(19) United States
(12) Patent Application Publication
(10) Pub. No.: US 2005/0182781 A1
(43) Pub. Date: Aug. 18, 2005

(54) System for consulting and/or updating dns servers and/or ldap directories

(76) Inventor: Bertrand Bouvet, Perros-Guirec (FR)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/517,813

(22) PCT Filed: Jun. 5, 2003
(86) PCT No.: PCT/FR03/01691

(30) Foreign Application Priority Data
Jun. 14, 2002 (FR) 02/07510

(51) Int. Cl. G06F 17/00

(52) U.S. Cl. 707/102

(57) ABSTRACT

A database in a system for consulting and/or updating one or more resource records, is stored by a domain name server, (DNS server), or a directory server, (the LDAP server), indirectly accessed from a DNS server. A communication arrangement enables the system to receive from a telecommunication terminal a request for consultation and/or modification of the record or a programming of such a request. A controller determines, from the consultation and/or modification request transmitted to the system or previously programmed in the system, a domain name and an operation to be performed on the record. A protocol manager searches, from the domain name, the IP address of the server storing the database and, according to the operation, transmits to the server a request to read or update the record.

The present invention concerns a system for consulting and/or updating DNS (Domain Name System) servers and/or LDAP (Lightweight Directory Access Protocol) directories from a terminal. The present invention in particular enables a subscriber, from any terminal, to consult and update a telecommunication resource record stored in a DNS or LDAP server.

DNS (and LDAP) servers are used in the data processing world for naming machines (for example: association of a web URL with an IP address corresponding to the web server storing this web site). These servers are usually consulted by data processing machines by means of software commonly called RESOLVER, available in the majority of terminals or data processing servers. This software makes it possible to extract information from a DNS server in response to the request from a client. This information may be available directly from the first DNS server consulted or from a DNS server referred to by the first, and so on if necessary by successive indirections. The contents of the DNS servers are updated by “administrator” specialists rather infrequently (updating of flat files under a UNIX platform or dedicated application via IHM under Windows server platforms). The format of the contents of the servers and requests are defined in a protocol, referred to as the DNS protocol, described in the documents RFC 1034 and RFC 1035, available on the IETF web site (www.ietf.org).

In addition, DNS servers are now called on to fulfil a role in the context of the ENUM service aimed at offering subscribers widespread portability of telephone numbers. This ENUM service uses the international telephone dialling system defined by the ITU under the recommendation E.164. More precisely, the ENUM service enables any subscriber having a unique E.164 telephone number (a telephone number of the type +33296053859) to be joined by various means according to his preferences configured in a profile stored in the network by a DNS server. For example, the unique E.164 telephone number of the ENUM subscriber can be associated with a mobile telephone number (+33686166924), with a fixed telephone number (+33296916404), with an e-mail address (bertrand.dupont@rd.francetelecom.com), with a web site URL (http://www.bertrand.dupont.com), with a VoIP telephone number (sip:bertrand.dupont@sip.francetelecom.com), with a fax number, etc.

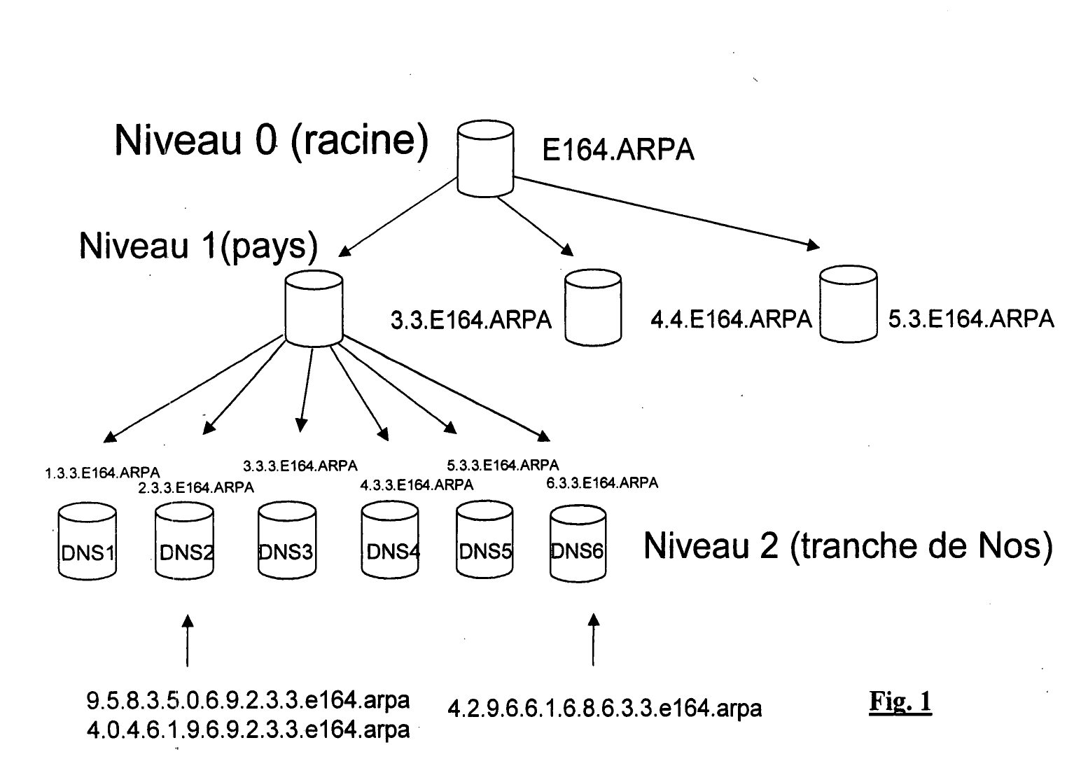

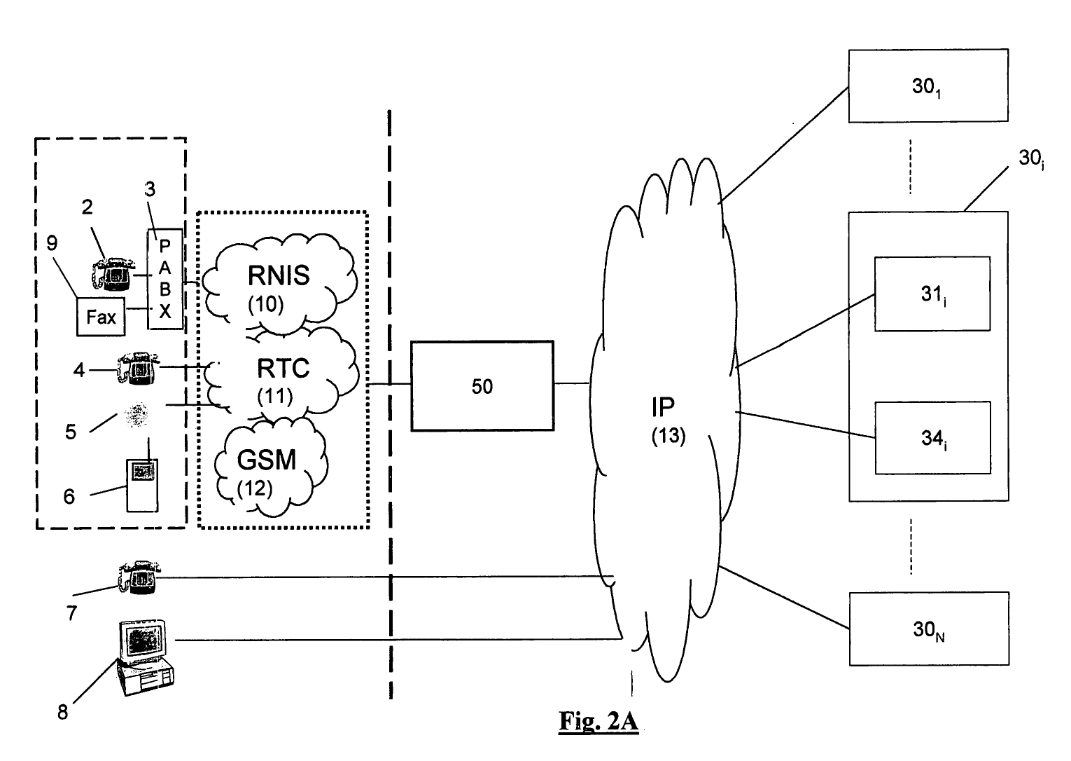

All this information can be stored in a standard DNS server and accessed according to the hierarchical delegation model depicted in FIG. 1.

Access takes place through a root DNS server (E164.ARPA). Each country then has a unique telephone code (33 for France) and a DNS server is managed at level 1 by each country (3.3.E164.ARPA for France). Finally, telecommunications operators or ENUM service providers manage DNS servers (indicated in FIG. 1 by DNS 1 to DNS 6) according to the telephone resources (tranche of E.164 telephone numbers) which are allocated to them. The model adopted is a division by tranches: 5 tranches of fixed STN telephone numbers with prefixes ranging from 1 to 5 and one tranche of mobile telephone numbers identified by the prefix 6.

A path in the DNS server tree is associated with a telephone number to the E.164 format. More precisely, each telephone number to the E.164 international format is reversed, the “+” code is omitted, a point is added between each digit and the result obtained is joined to the e164.arpa domain so as to transform the telephone number into a unique Internet domain name. For example, the telephone number +33686166924 gives, after transformation, the Internet domain name 4.2.9.6.6.1.6.8.6.3.3.e164.arpa.

In addition, with each telephone number to the E.164 format there is associated a record comprising one or more resource records (Resource Record or RR) stored in the corresponding level 2 server, each resource record being able to comprise one or more fields. For example, with a telephone number to the E.164 format there can be associated NAPTR (Naming Authority PoinTeR) resource records as defined in the documents RFC 2915 and RFC 2916, available on the IETF site. Schematically, an NAPTR resource record indicates a telecommunication service (telephone or fax number, e-mail address, web site etc) associated with a priority level. The term ENUM record (or ENUM profile) will hereinafter be used for a set of NAPTR records associated with an Internet domain name. For example, if the following ENUM profile is stored in a level 2 DNS server:

$ORIGIN 9.5.8.3.5.0.6.9.2.3.3.e164.arpa.

| | | |
|---|---|---|
| IN NAPTR 100 10 “u” | “tel+E2U” | “!\hat{ }.*$!tel:+33296053859!” |
| IN NAPTR 100 11 “u” | “tel+E2U” | “!\hat{ }.*$!tel:+33296916404!” |
| IN NAPTR 100 12 “u” | “tel+E2U” | “!\hat{ }.*$!tel:+33686166924! |
| IN NAPTR 100 13 “u” | “sip+E2U” | “!\hat{ }.*$!sip.bdupont@sip.ftrd.fr!” |
| IN NAPTR 120 10 “u” | “mailto+E2U” | “!\hat{ }.*$!mail2:bdupont@rd.ftrd.fr!” |
| IN NAPTR 130 10 “u” | “http+E2U” | “!\hat{ }.*$!http://www.bdupont.fr!” |

The header line indicates an Internet domain name corresponding to the E.164 telephone number. The RESOLVER software makes it possible to access the record from the domain name. A telecommunication resource or service corresponds to each NAPTR record in the above example. Two numerical fields follow the term “NAPTR”, it is a case respectively of the service priorities: “Order” and “Preference”. The lower the value of the “Order” field, the higher the priority of the service and, if several services have an identical order level, the lower the associated preference value, the higher the priority of the service. Thus the above lines of record correspond to decreasing priorities.

The 1^{st} line corresponds to the fixed telephone service 0296053859 with an order=100 and a preference=10.

The 2^{nd} line corresponds to the fixed telephone service 0296916404 with an order=100 and a preference=11.

The 3^{rd} line corresponds to the mobile telephone service 0686166924 with an order=100 and a preference=12.

The 4^{th} line corresponds to the IP telephone service via SIP to the SIP address bdupont@sip.ftrd.fr with an order=100 and a preference=13.

The 5^{th} line corresponds to the e-mail electronic mail service whose destination address is bdupont@rd.ftrd.fr with an order=120 and a preference=10.

Finally, the 6^{th} line corresponds to the web service whose access URL is http://www.bdupont.fr with an order=130 and a preference=10.

The meaning of this record is as follows. If it is sought to join the E.164 telephone number (+33296053859), the RESOLVER software transmits a request to the level 2 DNS server with the name of the corresponding Internet domain (9.5.8.3.5.0.6.9.2.3.3.e164.arpa). In return, the level 2 DNS server (DNS2) will supply in the response the list of telecommunication resources (also hereinafter referred to as services) associated with the telephone number +33296053859, as given by the record. The RESOLVER software and the ENUM service can then exploit all or part of these resources in sequential mode (the system will attempt to join the service with the highest priority and then, in the absence of a response or in the case of the line being busy, the system will attempt to join the service of lower priority, etc) or in broadcast mode (the ENUM service will then attempt to join all the services simultaneously).

The modification of the ENUM profiles in a DNS server does not adapt well to the method of updating by administrator as known from the prior art. This is because, unlike Internet domain names, the conventional telecommunication services such as telephone or fax are liable to frequent change. What is more, it is sometimes necessary to program these changes automatically on a daily or even hourly base. It is then extremely difficult, for reasons of availability and flexibility, to have the changing configuration of an ENUM profile supported by its own telecommunications operator or its ENUM service provider.

A particular problem at the basis of the invention is to enable a subscriber to have a simple and rapid consultation and/or modification of his ENUM profile stored in a DNS server or an LDAP directory.

In more general terms, the problem at the basis of the invention is to allow a simple and rapid consultation and/or modification of one or more resource records stored in a DNS or LDAP server, and this from any conventional terminal.

The problem at the basis of the invention is resolved by a system for consulting and/or updating a record stored in a first database, the said record comprising one or a plurality of resource records, the said first database being stored by a domain name server, referred to as a DNS server, or a directory server, referred to as an LDAP server, able to be accessed by indirection from a DNS server, the said system comprising:
communication means enabling the said system to receive from a telecommunication terminal a request for consultation and/or modification of the said record or a programming of such a request;
control means adapted to determine, from said consultation and/or modification request transmitted to the said system or previously programmed in the said system, a domain name and an operation to be performed on the said record;
protocol management means adapted to seek, from the said domain name, the IP address of the said server storing the said first database and, according to the said operation, to transmit to the said server a request to read or update the said record.

Advantageously, the said system comprises authentication means adapted to authenticate at the application level the sender of the said request from authentication information stored in a second local or remote database.

When the sender of the said request has been authenticated, the said protocol management means make it possible to transmit a consultation request according to the DNS protocol (DNS Query) to the said DNS server, the request having the said domain name as its argument, and to receive a first response from the said server.

According to one embodiment, the control means are adapted to determine the said domain name from a subscriber identifier, which may be the E.164 telephone number of the said subscriber.

The control means are then adapted to extract information and to determine, according to the said request, an operation to be performed on a resource record of the NAPTR type.

According to other embodiments the control means are adapted to extract information and to determine, according to the said request, an operation to be performed on one or more resource records of the type A, NS, MD, MF, CNAME, SOA, MB, MG, MR, NULL, WKS, PTR, HINFO, MINFO, MX, TXT.

The characteristics of the invention mentioned above, as well as others, will emerge more clearly from a reading of the following description of an example embodiment, the said description being given in relation to the accompanying drawings, amongst which:

FIG. 1 illustrates schematically the delegation model used in the ENUM service;

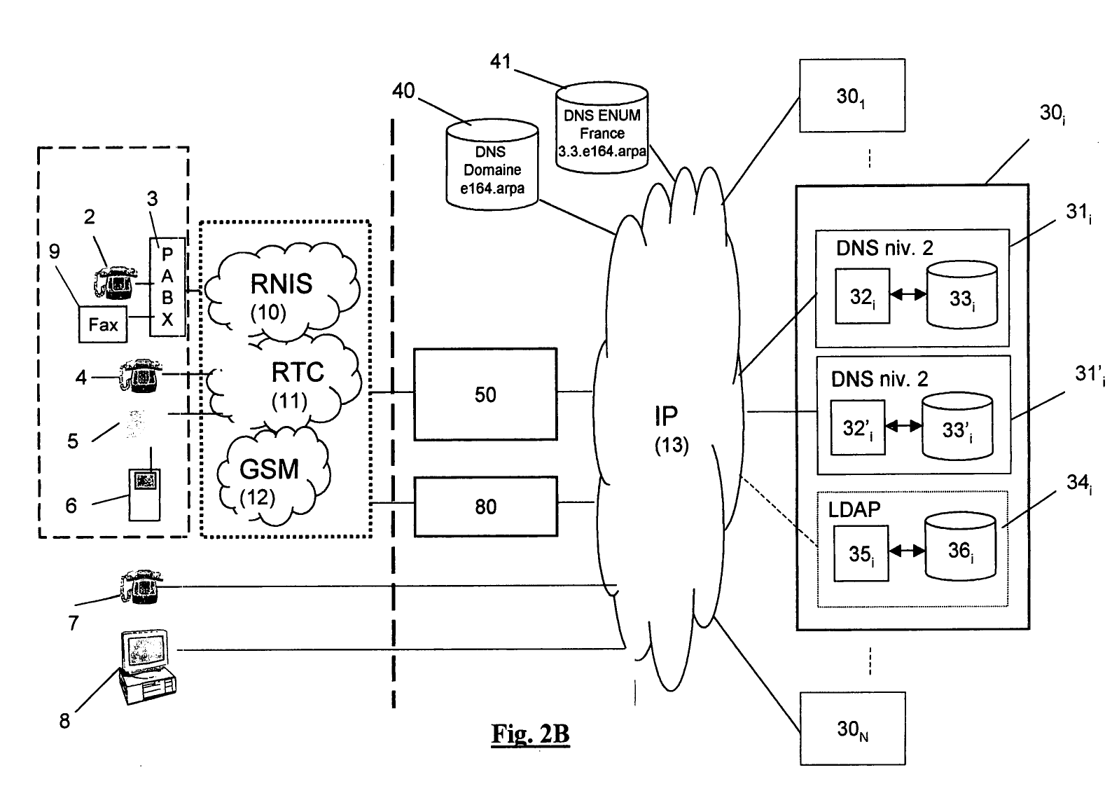

FIG. 2A illustrates schematically an example of an environment of the system according to the invention;

FIG. 2B illustrates schematically the environment of FIG. 2A in the context of the ENUM service;

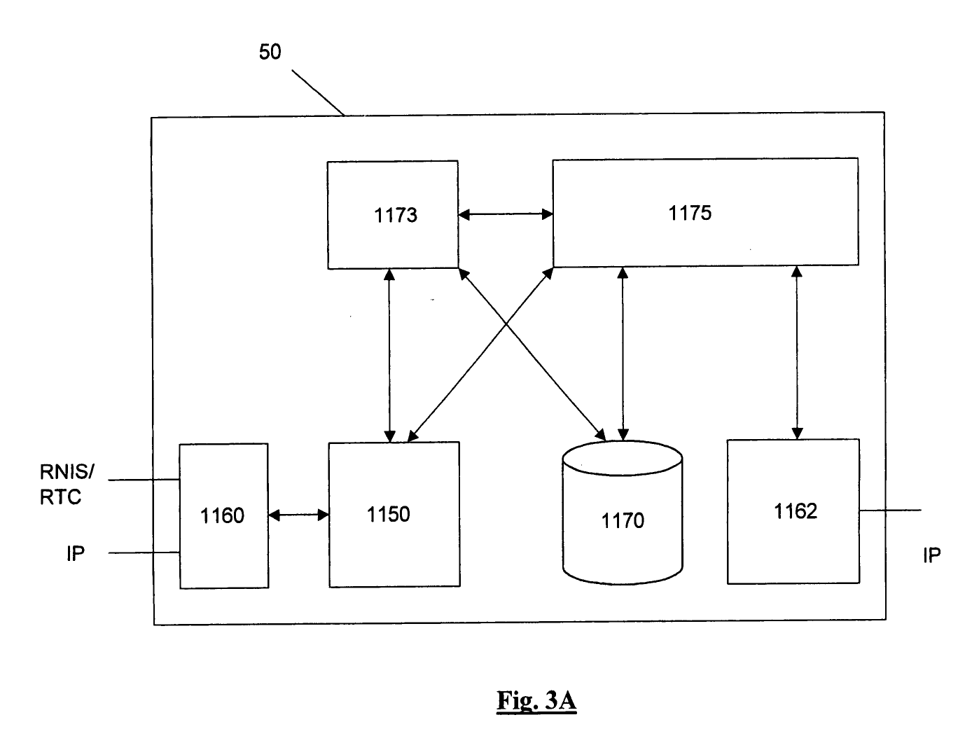

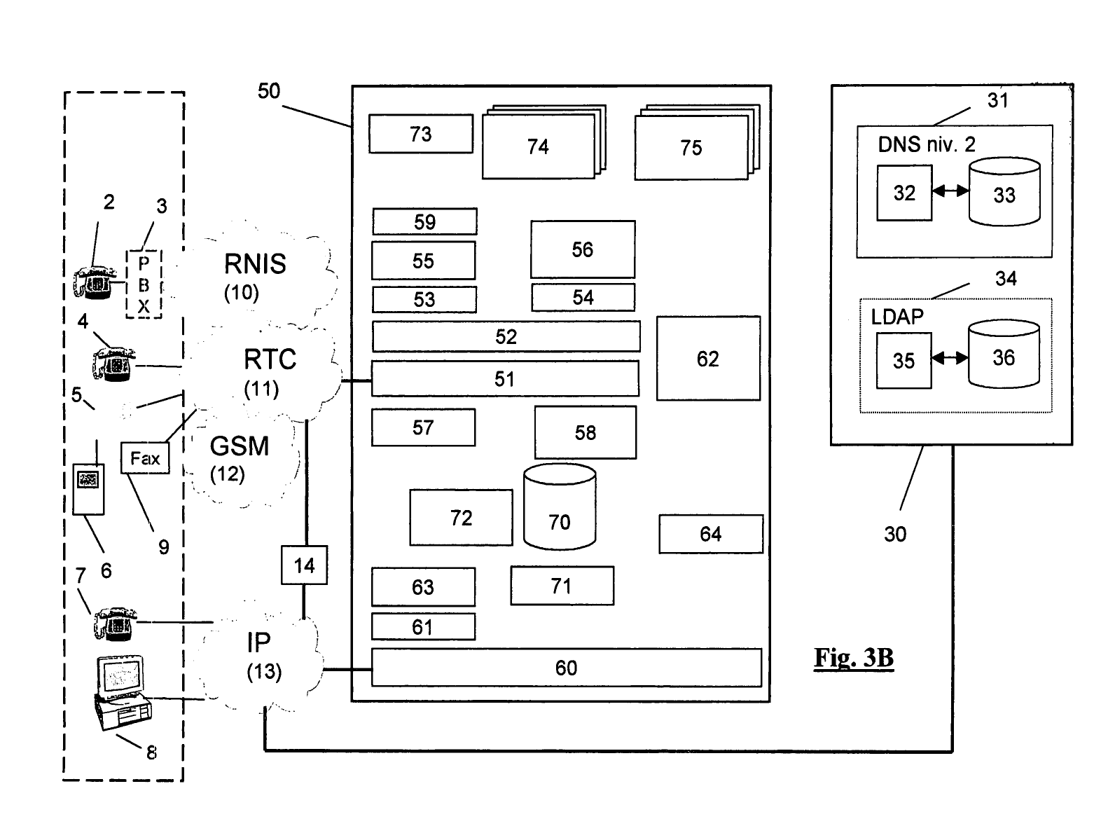

FIG. 3A depicts the outline diagram of the consultation/updating system according to the invention;

FIG. 3B depicts an example of a consultation/updating system according to the invention;

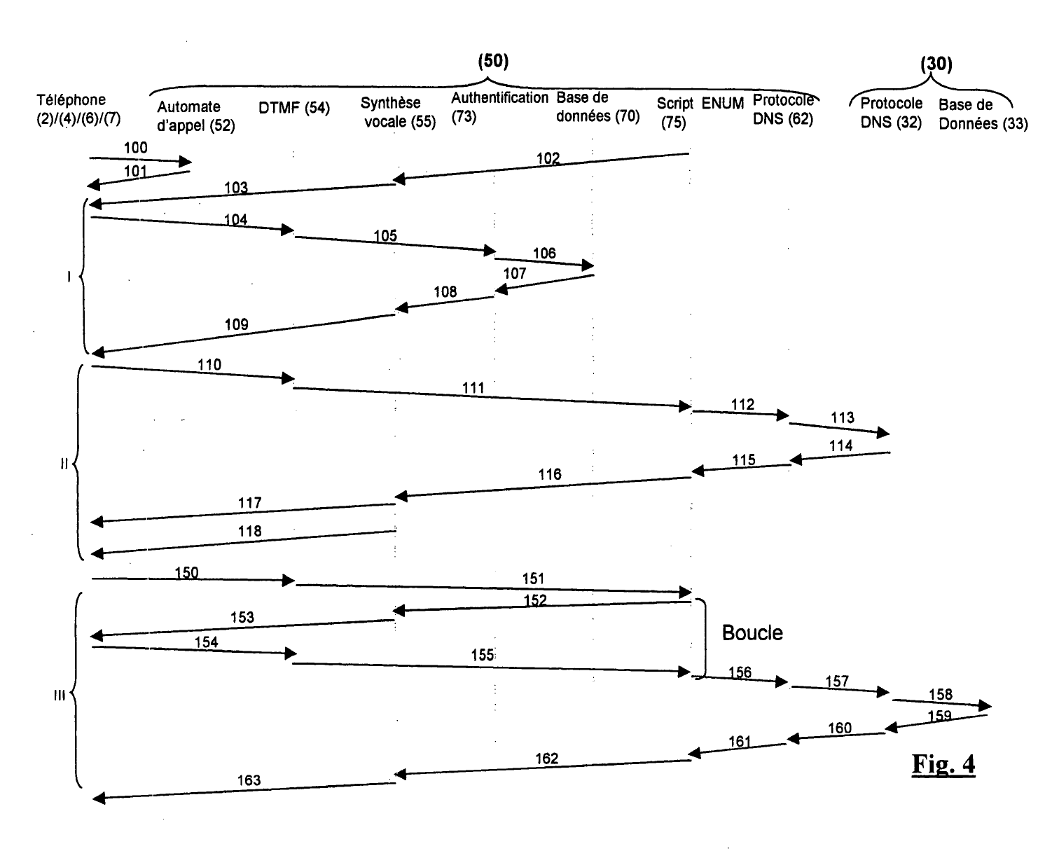

FIG. 4 depicts schematically a consultation and manual updating procedure for an ENUM profile with access in voice mode;

FIG. 5 depicts schematically a consultation and manual updating procedure for an ENUM profile by sending SMS messages;

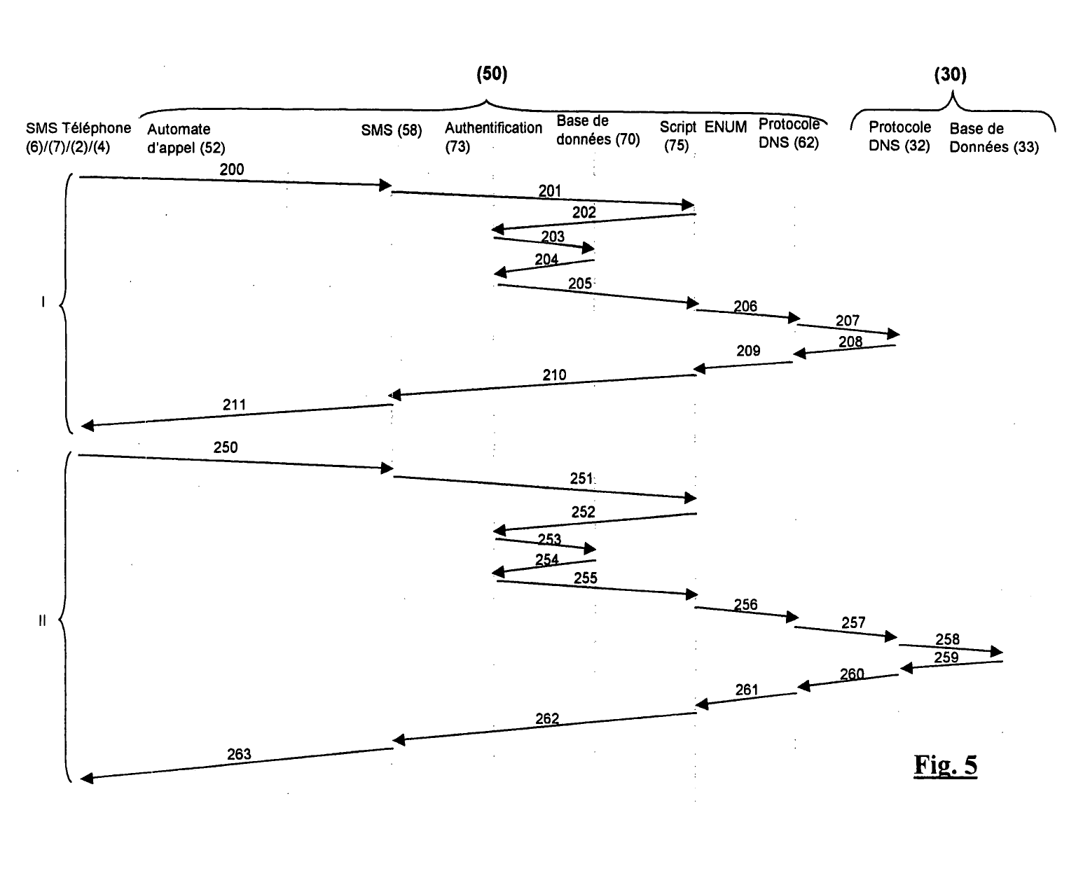

FIG. 6 depicts schematically a consultation and manual updating procedure for an ENUM profile by the web;

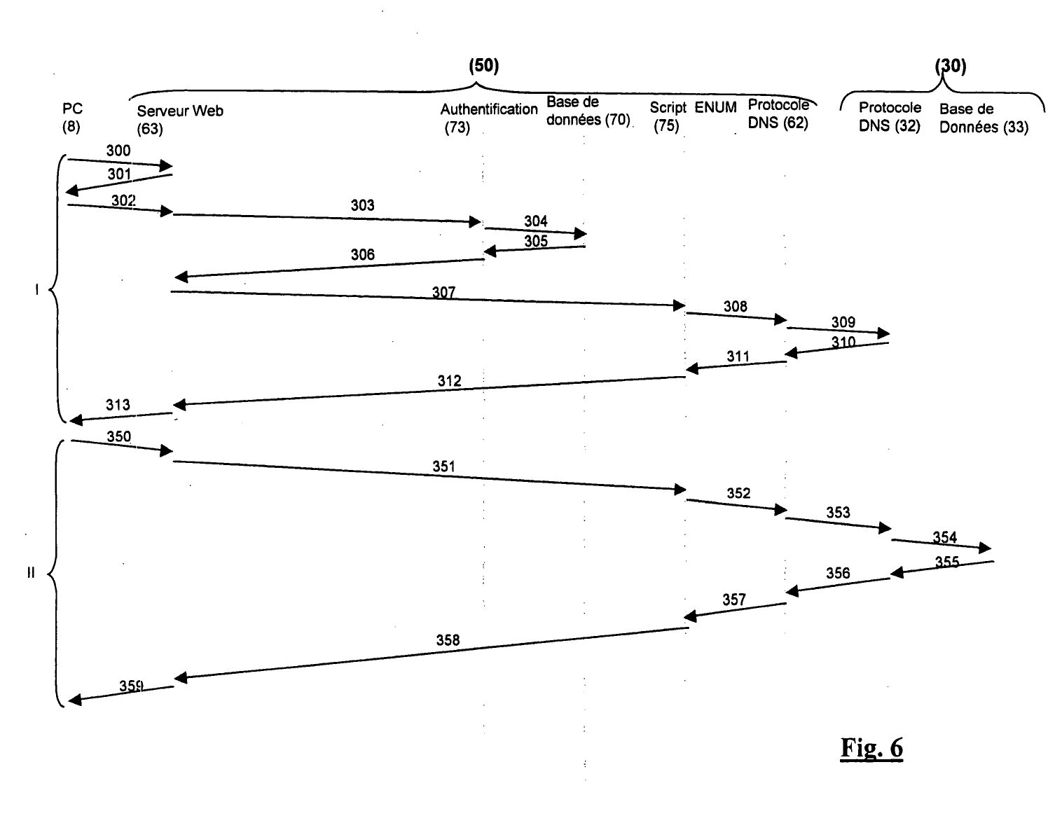

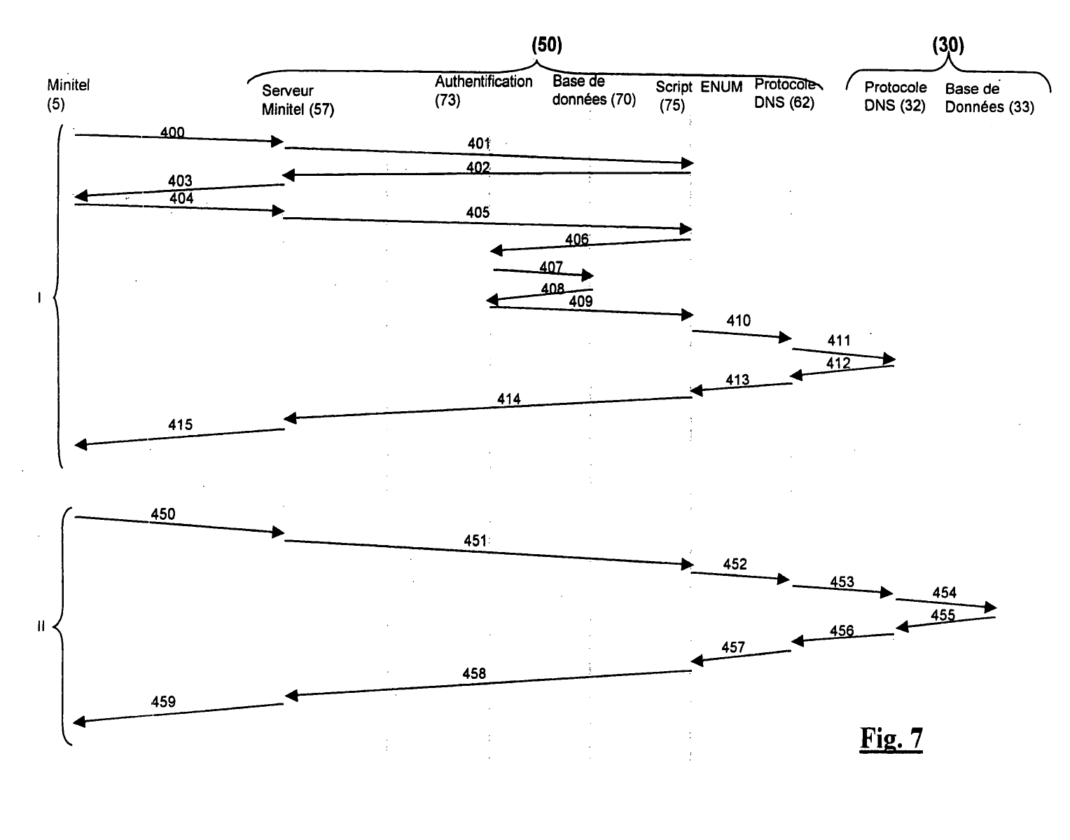

FIG. 7 depicts schematically a consultation and manual updating procedure for an ENUM profile using a Minitel;

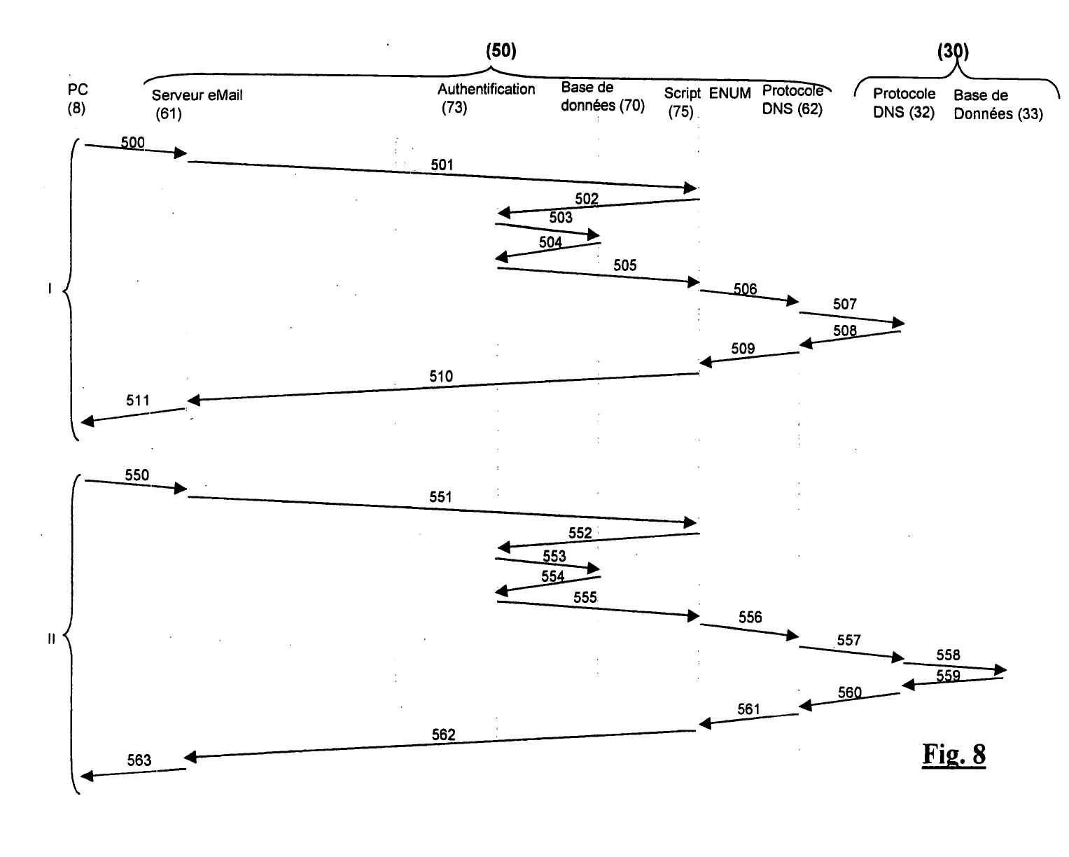

FIG. 8 depicts schematically a consultation and manual updating procedure for an ENUM profile by e-mail;

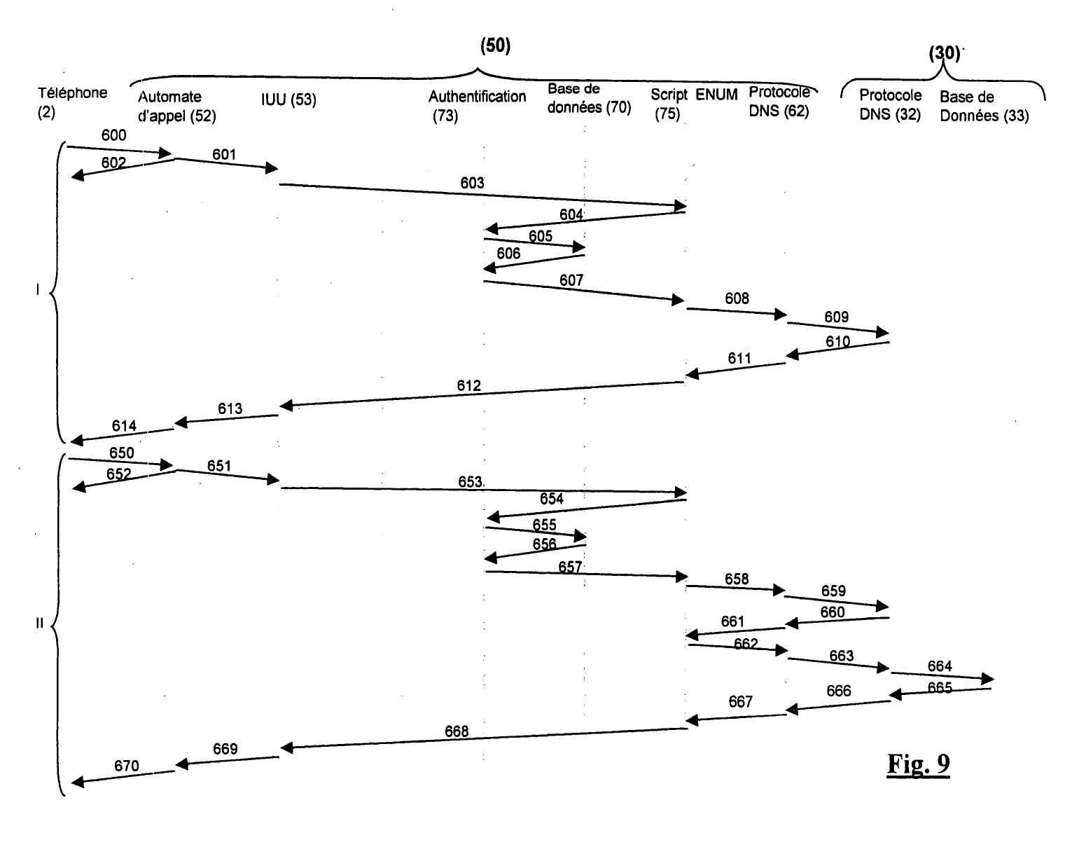

FIG. 9 depicts schematically a consultation and manual updating procedure for an ENUM profile by UUI from an ISDN terminal;

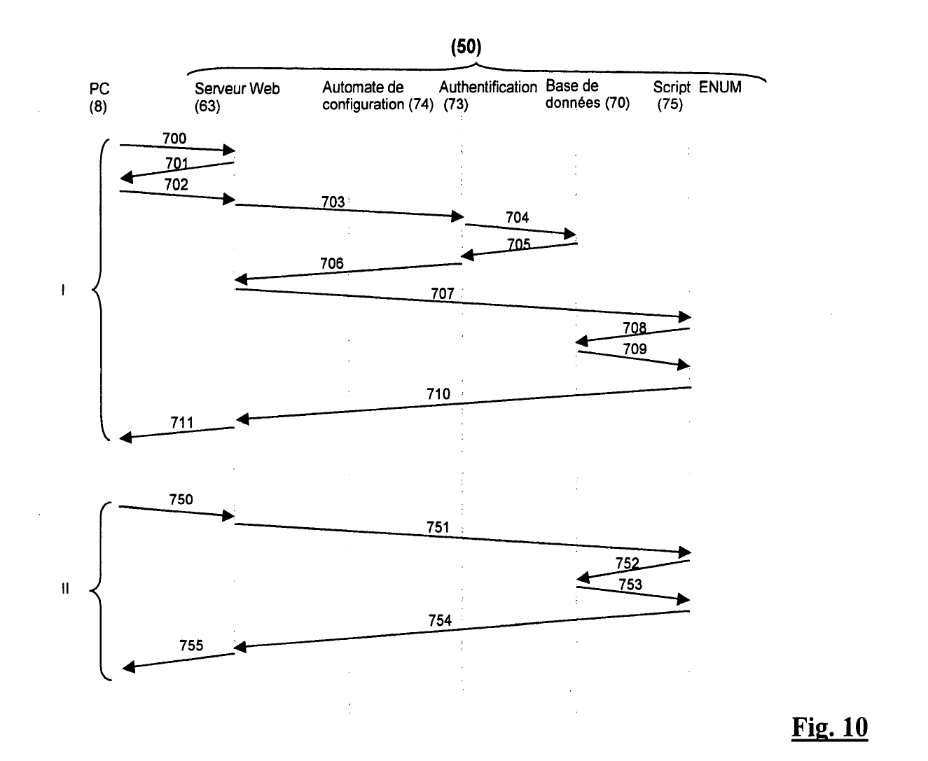

FIG. 10 depicts schematically a procedure for programming the automatic updating of an ENUM profile;

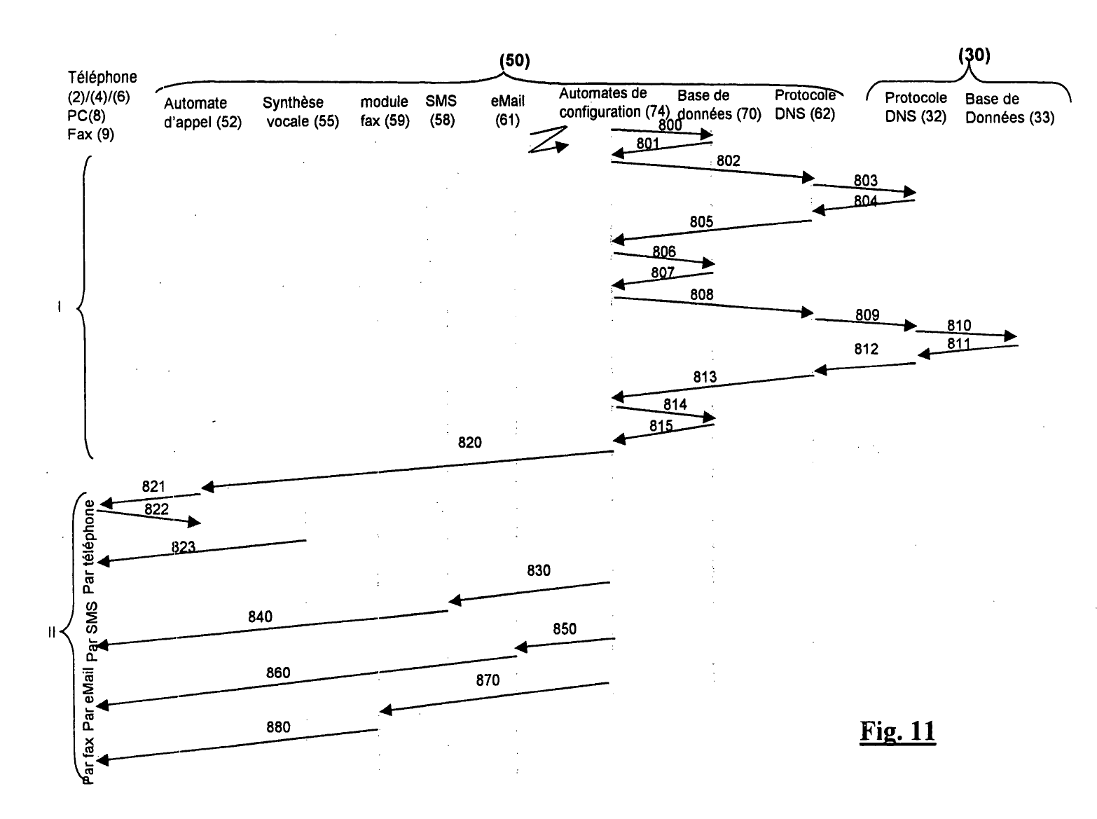

FIG. 11 depicts schematically a procedure for the automatic updating of an ENUM profile;

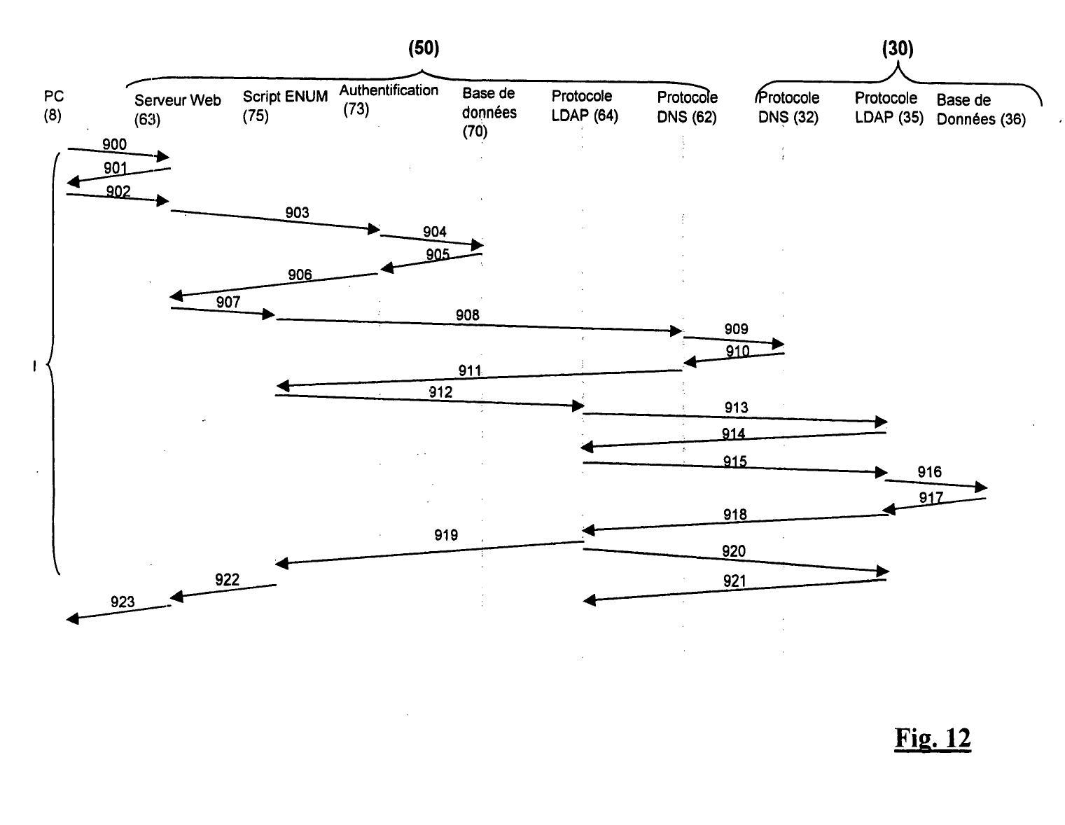

FIG. 12 depicts schematically a procedure for consulting an ENUM profile when the latter is stored in an LDAP directory;

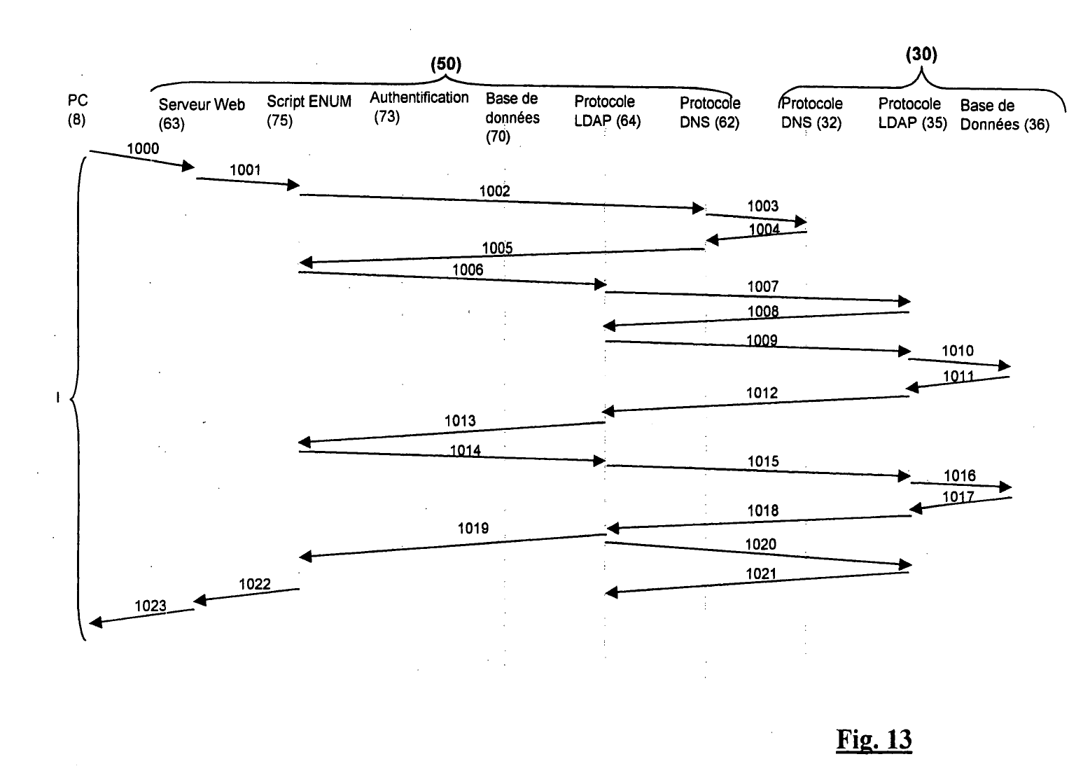

FIG. 13 depicts schematically a procedure for updating an ENUM profile when the latter is stored in an LDAP directory.

FIG. 2A illustrates an example of an environment of the system according to the invention.

Telecommunication resource management service providers, hereinafter referred to as service providers, have been shown schematically at 30₁, . . . , 30_{N}. Each service provider has a DNS server (31ᵢ) or LDAP server (34ᵢ) storing a database and more generally several redundant servers so as to increase the reliability of access to the service. The database contains a telecommunication resource record for all the service provider subscribers in question.

The system (50) according to the invention can be connected on the one hand to the public telephone network via a standard interface of the analogue or digital type T0 or T2 and on the other hand to the IP network via a standard interface of the Ethernet type.

More precisely, the system (50) is connected to the Internet if the present invention is accessible to any subscriber, whatever his service provider, and can be connected to an Intranet if the present invention is accessible solely to subscribers of a service provider.

The system (50) can be accessed by an ISDN telephone terminal (2) connected either directly or through a PABX (3) to the ISDN network (10). It should be stated that the ISDN network is interconnected natively to the STN network.

The system (50) can also be accessed by means of a conventional telephone terminal (4) or a Minitel terminal (5) connected to the STN network (11).

The system (50) can also be accessed by a GSM mobile terminal (6) or a UMTS terminal, not shown (the GSM and UTRAN networks are interconnected natively to the STN network).

The system (50) can be accessed by means of an IP telephone terminal (7) connected to the IP network (13).

Finally, the system (50) can be accessed by means of a microcomputer (8) connected to the IP network either through an Ethernet interface (local business network) or by modem (STN/ISDN/ADSL/cable/satellite etc).

The subscriber will also be able to receive notifications from the system (50) by virtue of one of the terminals envisaged above or by means of a fax terminal (9).

FIG. 2B illustrates an example of an environment of the system according to the invention, in the context of an ENUM service. The elements bearing the same reference numbers are identical to those of FIG. 2A.

The level 0 (root) ENUM DNS server has been indicated at 40. This server has available all the IP addresses referencing all the level 1 ENUM DNS servers, corresponding to the codes of the various countries (33 for France, 34 for Spain, 44 for the UK etc). For example, 41 shows the level 1 ENUM DNS server corresponding to France.

Each ENUM operator or service provider has at least one first level 2 ENUM DNS server (31ᵢ), referred to as the primary server, with redundancy provided by at least one second level 2 ENUM DNS server (31′ᵢ), referred to as the secondary server, in order to ensure good reliability of service. The primary (or respectively secondary) server stores a database 33ᵢ (or respectively 33′ᵢ). In each level 2 server there is stored, for each E.164 telephone number for a subscriber to the ENUM service, a profile composed of the various telecommunication resources of the subscriber, each resource corresponding to an access means (for example fixed office telephone, fixed home telephone, mobile telephone, IP telephone, office e-mail address, mobile e-mail address, business fax number, etc) as well as the priorities allocated to each of these access means. Each telecommunication resource is declared by means of an NAPTR resource record, as seen above. The priority of a resource is determined by the content of the Order and Preference fields of the NAPTR resource record, as defined in the document RFC 2915 of the IETF and exemplified in the introductory part.

An ENUM service provider A (30ᵢ) can also have an LDAP server (34ᵢ) storing an LDAP dynamic directory (36ᵢ) as defined in the document RFC 1959 of the IETF. The advantage of this configuration is to make it possible to manage the ENUM profiles by indirection not in the level 2 ENUM DNS but in the LDAP dynamic directory. The advantage procured consists of no longer modifying the profile of the ENUM client at the level 2 ENUM DNS server but directly in the LDAP directory, which for its part is designed to store dynamic profiles. In this case, the level 2 ENUM DNS (31ᵢ) contains for example the following profile for all the E.164 telephone numbers commencing with the prefix “+332”:

$ORIGIN 2.3.3.e164.arpa.

IN NAPTR 100 10 “u” “ldap+E2U”
“!\hat{ }.+332(.*)$!ldap://ldap.providerA.fr/cn=01!”

The LDAP directory (36ᵢ) is accessed by indirection from the level 2 ENUM DNS server and contains the resource records for the various subscribers of provider A.

An ENUM server or gateway (80) can consult an ENUM service provider (30ᵢ) in order to know the list of telecommunication resources of an ENUM subscriber. To do this, the RESOLVER software transforms the E.164 unique number of the subscriber into a domain name as seen above and by successive indirections accesses the level 2 ENUM DNS server (31ᵢ) and, where applicable, after supplementary indirection to the LDAP server (34ᵢ). The service provider returns the list of resources of the subscriber in question with the associated priorities. The ENUM server or gateway (80) can then, according to circumstances, attempt to join the subscriber by successively using the resources, in decreasing order of priority, or join the subscriber by means of all his resources.

FIG. 3A shows the outline diagram of the updating system (50) according to the invention.

The system comprises communication means (1150) enabling a subscriber to dialogue with the said system and in particular:
to transmit an authentication request to the subscriber;
to receive from the said subscriber information allowing his authentication;
receiving from the said subscriber a request to modify a record (referred to as a manual request) or a request for automatic modification (referred to as a programmed request) according to a time or geographical criterion;
to transmit the content of a record prior or subsequent to the modification request;
to transmit to the said subscriber an update confirmation of location when the modification requested has indeed been made and update invalidation when it has not been able to be made;
to transmit to the said subscriber, at the end of consultation or review, an automatic modification request previously recorded in the said system;
to transmit to the said subscriber a history of modifications made.

The system also comprises interface means (1160) for connecting the said communication means to the STN/ISDN network and/or to an IP network (Internet or Intranet).

The system also comprises authentication means (1173) cooperating with the communication means in order to authenticate at the application level a sender of a consultation and/or update request. Authentication at the application level has the advantage of enabling a subscriber to operate from any terminal. The authentication means use to do this authentication information stored in a local or remote database (1170).

Apart from the above-mentioned information, the database (1170) can in particular contain automatic modification programs relating to various subscribers, the IP addresses of the servers of the various telecommunication resource management providers, the histories of manual or automatic modifications of the records and the addresses to which the update confirmation/invalidation notifications must be sent.

The system (50) also comprises protocol management means (1162) fulfilling amongst others the RESOLVER function. In particular the protocol management means are adapted to seek, where necessary by successive indirections, the content of a resource record (RR) by means of a domain name. The protocol management means can for this purpose transmit consultation requests according to the DNS protocol (DNS Query). In addition, the protocol management means can update resource records from update requests (DNS Update). According to one embodiment, if the resource records are stored in an LDAP directory, the protocol management means will also allow consultation of a record in an LDAP directory (sending of an LDAP Search request) as well as the updating of this record (sending of an LDAP Modify request). When the updating has been performed, the protocol means receive acknowledgement from the server of the telecommunication resource management provider.

The control means 1175 coordinate the aforementioned means and in particular:
order from the communication means the transmission of an authentication request;
after authentication of the subscriber by the authentication means (1173), request the protocol means (1162) to transmit a consultation request, format the response and retransmit it in intelligible form to the subscriber via the communication means;
from a request to modify a resource record by a subscriber, determine an operation to be performed on the said record and an identifier of the subscriber;
on reception of update confirmation/invalidation by the protocol means, notify the conformation/invalidation to the subscriber via the communication means.

FIG. 3B illustrates an example embodiment of the invention in the context of an ENUM service.

The elements bearing the same reference numbers are identical to those of FIG. 2A. In particular, the subscriber can contact the updating system (50) by means of one of the terminals envisaged above. There is shown at (30) a telecommunication resource management service provider comprising a level 2 DNS server (31), referred to as the primary server, with redundancy provided by a secondary server (not shown). The server (31) comprises a database (33) and a DNS protocol stack (32) integrating the DNS protocols described in the documents RFC 1034 and RFC 1035. The protocol stack also integrates the DNS protocols described in the documents RFC 2136 and RFC 2137 intended to allow the updating (DNS Update) of a resource record (RR). Optionally, the resource management service provider also comprises an LDAP directory server (34) storing a database (36). The LDAP directory server comprises an LDAP protocol stack (35).

The communication means of the system (50) consist of the following modules:
a module responsible for the processing of the incoming and outgoing telephone calls (52). This module manages the establishment and dropping of the communication;
a user to user information (UUI) management module (53) for extracting and transmitting UUI information;
a module (54) for processing DTMF codes. This module is responsible for recovering the DTMFs entered by the subscriber;
a voice synthesis module (55);
a module (56) for broadcasting pre-recorded voice files concatenated in order to form sentences;
a videotex server (57);
a module for receiving and sending SMSs (58);
a fax sending module (59);
an SMTP server (61) for sending and receiving e-mail;
a dynamic Web server (63).

It should be noted that the system can also comprise a voice recognition module (not shown) adapted to recognise information pronounced by the subscriber.

The communication means are connected to the outside by means of an STN and/or ISDN interface (51) and an IP interface (60). The first is based either on a multiport STN analogue card or on a T0 (2 channel) or T2 (30 channel) ISDN card. The second is an Ethernet interface. The gateway indicated by (14) states that the STN/ISDN and IP networks are natively interconnected in VoIP protocol (H323/SIP).

The system (50) comprises, as before, authentication means (73) allowing the applicative authentication of subscribers to the service from authentication information, for example pairs of pseudonyms (Login_Id) and passwords stored in a local or distant database (70). In addition, the database comprises the identifiers of the various ENUM service providers (such as 30), the IP addresses or the machine names of the two-tier DNSs, requests for automatic modification of an ENUM profile, the histories of manual or automatic modification of ENUM profiles, and the addresses of notification of modification of the ENUM profile (fax No, SMS, e-mail).

The system also comprises a DNS protocol management module (62), preferably in its secure form (DNSSec). This module in particular fulfils the role of RESOLVER for reading the resource records.

Where necessary, an LDAP protocol management module (64) is added thereto to allow reading and modification of records in an LDAP directory.

The system also comprises a module (72) for configuring the addresses of the level 2 DNS servers and a module (71) responsible for updating the manual or automatic modifications of the ENUM profiles and where necessary to produce statistics for exploiting the system.

The control means consist firstly of a module (74) responsible for the automatic configuration of ENUM profiles from automatic modification requests programmed by subscribers and stored in the database (70) and secondly a module (75) responsible for the “manual” configuration of the ENUM profiles. The latter manages ENUM scripts, in particular an ENUM profile reading script (it will be recalled that an ENUM profile consists of a list of NAPTR resource records), scripts for modifying the NAPTR resource record fields and in particular order, preference and service fields (e-mail address, telephone number, e-mail address etc). If it is wished to provide the consultation and/or updating of DNS resource records other than NAPTR, supplementary scripts must be provided for their modification.

FIG. 4 illustrates schematically a procedure for the consultation and manual modification of an ENUM profile in voice mode via a fixed or mobile telephone of the STN, ISDN, GSM or IP type.

The ENUM subscriber at step 100 sends a free telephone call (green number type) or a paid one according to a geographical or fixed-rate remuneration of the audiotel or coloured numbers type from a fixed STN (4) or ISDN (2) terminal connecting to the public network or behind a PABX (3) or a mobile terminal (6) of the GSM type, or from an IP terminal (7) destined for the STN/ISDN interface (51) of the system (50). The automatic call processing controller (52) automatically accepts the incoming call at step 101. The ENUM script module (75) at step 102 gives the order to the voice synthesis module (55) or to the voice file broadcast module (56) to broadcast to the ENUM subscriber at step 103 a voice announcement inviting the ENUM subscriber to enter his E.164 ENUM number as well as his pseudonym and password. The ENUM subscriber at step 104 enters via his keypad this information which is conveyed in the band in the form of DTMF and which is intercepted by the DTMF processing module (54). This information is supplied at step 105 to the authentication module (73), which interrogates the local or remote database (via for example an interface of the ODBC type (standing for Open DataBase Connectivity)), making a search on the E.164 ENUM number. This supplies, at step 107, the corresponding authentication information to the authentication module (73). The latter compares the pseudonym and password entered by the ENUM client with the authentication information contained in the database (70). In the event of agreement, the authentication module (73) at step 108 orders the voice synthesis module (55) or the voice file broadcast module to broadcast to the ENUM subscriber at step 109 an announcement of the type “In order to consult your ENUM profile hit the 1 key, to modify the attributes of your profile hit 2, to automatically configure your profile hit 3, to modify your pseudonym/password hit 4, to access your profile modification journal hit 5,” etc. If the ENUM subscriber hits the 1 key on his telephone keypad at step 110, the corresponding DTMF code is intercepted by the DTMF processing module (54) and is retransmitted at step 111 to the ENUM script module (75). The ENUM script (75) then detects that it is a case of an ENUM profile reading command. The ENUM script (75) then at step 112 sends an interrogation request to the DNS protocol module (62) supplying as an argument the E.164 address of the ENUM subscriber put in domain form (conversion of the E.164 telephone number of the type 33296053859 into (9.5.8.3.5.0.6.9.2.3.3.e164.arpa). The DNS protocol management module (62), which fulfils the conventional role of a RESOLVER, can first of all check whether the information is present in its cache following a previous consultation or interrogate (at step 113), according to the DNS standard protocol (DNS Query request), successively the level 0 DNS server, the level 1 DNS server, and then the level 2 DNS server by the DNS protocol stack (32). In order to gain in efficiency, the data of an NAPTR record are loaded into the random access memory of the DNS server (21). If the ENUM subscriber is actually recorded in the DNS server (31) of the ENUM service provider (30) then the DNS protocol stack (32) returns (at step 114) to the DNS protocol module (62) the list of corresponding NAPTR records. The DNS protocol module (62) is then responsible for retransmitting them to the ENUM script module (75) at step 115. The module (75) analyses and interprets the NAPTR records and generates a text which can be understood by the ENUM subscriber of the “Service No 1: telephone to 0296053859, service No 2: telephone to 0686166924, service No 3: e-mail to bertrand.dupont@rd.francetelecom.com,” etc type.

This text is sent to the voice synthesis module (55) at step 116, which is responsible for broadcasting this information to the ENUM subscriber at step 117. In the case where the voice file broadcast module (56) is used, the module (75) generates the concatenation of the voice files to be played. After broadcasting this information, the voice synthesis module (55) or the voice file broadcast module (56) once again broadcasts at step 118 the list of possible administration operations on the ENUM profile “In order to consult your ENUM profile hit the 1 key, to modify the attributes of your profile hit 2, to automatically configure your profile hit 3, to modify your pseudonym/password hit 4, to access your profile modification journal hit 5,” etc.

If the ENUM subscriber chooses the modification of his ENUM profile at step 150, this command is intercepted by the ENUM script module (75) at step 151, following the detection of the DTMF code by the DTMF processing module (54). The system (50) then enters an iterative dialogue based on the broadcast of voice messages to the ENUM subscriber from a text generated by the ENUM script module (75) (at step 152) according to the context and broadcast (at step 153) in voice form by the voice synthesis module (55) or by the module for broadcasting concatenated voice files (56). The latter validates the choices offered using its DTMF keypad at step 154 and the commands are transmitted at step 155 to the ENUM script (75). For example, the voice dialogue may be as follows:
→in order to modify the order/preference of your services hit 1, to modify the attributes of a service hit 2, to add a service hit 3, to delete a service hit 4, etc.
→4
→in order to delete the telephone number 0296053859 hit 1, to delete the telephone number 0686166924 hit 2, to delete the e-mail address bertrand.dupont@rd.francetelecom.com hit 3, etc.
→2
→To validate your choice hit 1, otherwise hit 2
→1
→To delete a service hit 1, to record your changes hit 2, to return to the main menu hit 0
→2

When the ENUM subscriber requests the changes to the ENUM profile to be taken into account, the ENUM script module (75) sends a modification demand request at step 156 to the DNS protocol module (62). The latter sends a command DNS UPDATE at step 157 to the DNS protocol module (32) of the DNS server (31) of the ENUM service provider (30). The IP address of the latter is stored in the database (70) and is found from the E.164 number of the ENUM subscriber. The DNS protocol module (32) updates the information in the random access memory of the server (31) and requests the updating of the database (33), which is generally a flat text file. The DNS protocol manages the modification number in this file so that the secondary DNS or DNSs can themselves reload this modification at predefined intervals of time. The database (33) confirms the updating at step 159, which results in a response to the demand request of step 160. The ENUM script (75) at step 116 intercepts the return code of this response and then at step 162 generates the confirmation/invalidation message regarding taking the modification into account. The voice synthesis module (55) or the voice file broadcast module broadcasts this information to the ENUM subscriber at step 163. The latter can then release the communication.

According to a variant of this procedure, in response to the voice messages, the subscriber can directly supply a response vocally. It is then the voice recognition module which determines the choice or the information contained in the response.

FIG. 5 illustrates schematically the procedure for consultation and manual modification of an ENUM profile via the sending of SMSs from mobile or fixed telephone terminals of the GSM, STN, ISDN or IP type. The ENUM subscriber at step 200 sends a formatted SMS (e.g.: E.164 No+pseudonym+password+request) as specified by the ENUM service provider (30) from a fixed STN (4) or ISDN (2) terminal connected to the public network or behind the PABX (3) or a mobile terminal (6) of the GSM type, or from an IP terminal (7), to the SMS module (58) of the present invention. The latter transmits the SMS at step 201 to the ENUM script module (75). This information is supplied at step 202 to the authentication module (73), which at step 203 interrogates the local or remote database (via an ODBC interface for example) making a search on the E.164 ENUM number. This supplies the corresponding information at step 204 to the authentication module (73), which is responsible for comparing the pseudonym and password entered by the ENUM client in the SMS with the authentication information contained in the database. In the case of agreement, the authentication module (73) at step 205 orders the ENUM script module (75) to process the request contained in the SMS. The ENUM script (75) detects that it is a case of a command to read the ENUM profile. Consequently the ENUM script (75) sends an interrogation request at step 206 to the DNS protocol management module (62), applying as an argument the E.164 address of the ENUM subscriber converted in the form of a domain (conversion of the E.164 telephone number of the type 33296053859 into (9.5.8.3.5.0.6.9.2.3.3.e164.arpa)). The DNS protocol management module (62), which fulfils the conventional role of a RESOLVER, interrogates (step 207) by means of a request (DNS Query) the level 0 DNS server, and then the level 1 DNS server, unless the information is already in its cache following a previous consultation of these servers. To gain in efficiency, the data of a DNS server are loaded into the random access memory of the server (21). If the ENUM subscriber is actually recorded in the DNS server (31) of the ENUM service provider (30), then the DNS protocol module (32) at step 208 returns the corresponding NAPTR records. The DNS protocol management module (62) is then responsible for retransmitting them to the ENUM script module (75) at step 209. The latter analyses and interprets the NAPTR records and generates a relatively synthetic text understandable to the ENUM subscriber (of the type “P1: Tel=0296053859, P2: Tel=0686166924, Pe: e-mail=bertrand.dupont@rd.francetelecom.com, P4: url=www.bertranddupont.fr, etc). This text is sent at step 210 to the SMS sending module (58), which sends the SMS (at step 211) to the telephone terminal originating the request (use of the Number of the caller).

At step 250 the ENUM subscriber sends a formatted SMS message (e.g. E.164 No+pseudonym+password+request type=ECR: P1: Tel=0686166924, P2: bertrand.dupont@rd.francetelecom.com) as specified by the ENUM service provider (30) from a fixed STN (4) or ISDN (2) terminal connected to the public network or behind the PABX (3) or a mobile terminal (6) of the GSM type, or from an IP terminal (7) to the SMS module (58) of the present invention. The latter transmits the SMS message at step 251 to the ENUM script module (75). This information is supplied at step 252 to the authentication module (73) which at step 253 interrogates the local or remote database (via an OBDC interface for example) making a search on the E.164 ENUM number. This supplies the corresponding information at step 254 to the authentication module (73), which is responsible for comparing the pseudonym and password entered by the ENUM client in the SMS message with the authentication information contained in the database. In the case of agreement, the authentication module (73) warns the ENUM script module (75) of this, which then processes the request contained in the SMS. The ENUM script (75) detects that it is a case of a command to update the ENUM profile with arguments. The ENUM script (75) checks the syntax of the command and, if it is correct, sends an update request at step 256 to the DNS protocol management module (62). The latter sends a DNS UPDATE command at step 257 to the DNS protocol module (32) of the DNS server (31) of the ENUM service provider (30). The IP address of the latter is stored in the database (70) and is found from the E.164 number of the ENUM subscriber. The DNS protocol module (32) updates the information in the random access memory of the server (31) and requests the updating of the database (33), which is generally a flat text file. The DNS protocol manages the modification number in this file so that the secondary DNS server or servers can themselves reload this modification at predefined intervals of time. The server (31) confirms the updating at step 259, which results in a response to the update demand request at step 260. The ENUM script (75) at step 261 intercepts the return code of this response and then at step 262 generates the confirmation/invalidation message relating to taking into account the modification before sending it to the SMS sending module (58), which is responsible for sending the SMS at step 263 to the telephone terminal originating the request (use of the number of the caller).

FIG. 6 illustrates schematically the procedure for consultation and manual modification of an ENUM profile by the web using a terminal having available a web browser (8).

The ENUM subscriber at step 300 requests the downloading of the web home page of the ENUM profile management service. This is returned at step 301 by the web server (63) of the present invention. This web page displays an authentication form to the ENUM subscriber. The latter enters his E.164 number and then his pseudonym and password. This information is transmitted at step 302 to the web server (63), which itself transmits it at step 303 to the authentication module (73). The authentication module (73) at step 304 interrogates the local or remote database (via an ODBC interface for example), making a search on the E.164 ENUM number. This supplies at step 305 the corresponding information to the authentication module (73) which is responsible for comparing the pseudonym and password entered by the ENUM client in the web form and the authentication information contained in the database. In the case of agreement, the authentication module (73) at step 306 notifies the web server module (63) that the authentication has succeeded. This sends at step 307, to the ENUM script module (75), a request to read the ENUM profile. Consequently the ENUM script (75) sends an interrogation request at step 308 to the DNS protocol module (62), supplying as an argument the E.164 address of the ENUM subscriber transformed in the form of a domain (transformation of the E.164 telephone number of the type 33296053859 into 9.5.8.3.5.0.6.9.2.3.3.e164.arpa). The DNS protocol module (62) which fulfils the conventional role of a RESOLVER interrogates (at step 309) after having checked whether the information is present in its cache following a previous consultation, using the DNS standard protocol (DNS Query request) successively the level 0 DNS server, the level 1 DNS server and then the level 2 DNS server. To gain in efficiency, the data of a DNS are loaded into the random access memory of the DNS server (31). If the ENUM subscriber is actually recorded in the DNS (31) of the ENUM service provider (30), the DNS protocol module (32) returns at step 310 the NAPTR records corresponding to the DNS protocol module (62). The latter retransmits them to the ENUM script module (75) at step 311, which interprets the NAPTR records and generates a relatively synthetic text understandable to the ENUM subscriber, of the type:

| | | |
|---|---|---|
| Priority 1 service | Tel: | 0296053859 |
| Priority 2 service | Tel: | 0686166924 |
| Priority 3 service | Mail: | b.dupont@rd.ft.com |
| Priority 4 service | Web: | www.bertranddupont.fr |

This text is sent at step 312 to the web server module (63), which downloads a web page provided with this information at step 313 to the Web terminal (8) of the ENUM subscriber.

The web page presented to the ENUM subscriber makes it possible, via an adapted graphical interface, to make normal ENUM profile changes: changes to priorities, addition of service, deletion of service, modification of the attributes of a service, etc. The modification request is sent at step 350 to the web server (63). The latter at step 351 transmits the request to the ENUM script module (75) which is responsible for formatting the request in accordance with the NAPTR inputs described by the ENUM protocol. The ENUM script (75) then sends an update request at step 352 to the DNS protocol module (62). The latter sends a command DNS UPDATE at step 353 to the DNS protocol module (32) of the DNS server (31) of the ENUM service provider (30). The IP address of the latter is stored in the database (70) and is found from the E.164 number of the ENUM subscriber. The DNS protocol module (32) updates the information in the random access memory of the server (31) and requests the updating of the database (33), which is generally a flat text file. The DNS protocol manages the modification number in this file so that the secondary DNS server or servers can themselves reload this modification at predefined intervals of time. The database (33) confirms the updating at step 355, which results in a response to the update demand request at step 356. The ENUM script (75) at step 357 intercepts the return code of this response and then at step 358 generates the confirmation/validation method relating to the taking into account of the modification before sending it to the web server (63), which is responsible for formatting the result web page before downloading it to the web terminal (8) at step 359.

FIG. 7 illustrates schematically the procedure for consultation and manual modification of an ENUM profile from a Minitel.

The ENUM subscriber connects to the Minitel service using the PAVI (Videotex Point of Access) function of the France Telecom network (for example calling the ENUM-FT code 3615). The minitel terminal (5) then goes into session with the minitel server (57) at step 400.

The latter at step 401 activates the ENUM script module (75) of the present invention, which then generates the home page of the service at step 402 and which is downloaded at step 403 onto the Minitel terminal (5) of the ENUM subscriber. This Minitel page displays an authentication form for the ENUM subscriber. The latter enters his E.164 ENUM number and then his pseudonym and password. This information is transmitted at step 404 to the Minitel server (57), which itself transmits it to the ENUM script module (75) at step 405. The latter redirects the request at step 406 to the authentication module (73). The authentication module (73) at step 407 interrogates the local or remote database (via an ODBC interface for example), making a search on the E.164 ENUM number. At step 408 the authentication information for the database is transmitted to the authentication module (73), which compares them with the pseudonym and password entered in the Minitel form. In the case of agreement, the authentication module (73) at step 409 notifies the ENUM script module (75) that the authentication has succeeded. The ENUM script module (75) then sends an interrogation request at step 410 to the DNS protocol module (62), supplying as an argument the E.164 address of the ENUM subscriber transformed in the form of domain (transformation of the E.164 telephone number of the type 33296053859 into 9.5.8.3.5.0.6.9.2.3.3.e164.arpa). The DNS protocol module (62), which fulfils the conventional role of a RESOLVER, interrogates (step 411), after having checked whether the information is present in its cache following a previous consultation, using the DNS standard protocol (DNS Query request) successively the level 0 DNS server, the level 1 DNS server and then the level 2 DNS server. Preferably, in order to gain in efficiency, the data of a DNS are loaded into the random access memory of the DNS server (31). If the ENUM subscriber is actually registered in a DNS server (31) of the ENUM service provider (30), the DNS protocol module (32) returns (at step 412) the corresponding NAPTR records. The DNS protocol module (62) is responsible for retransmitting them to the ENUM script module (75) at step 413. The latter analyses and interprets the NAPTR records and generates a relatively synthetic text understandable to the ENUM subscriber, of the type:

| | | |
|---|---|---|
| Priority 1 service | Tel: | 0296053859 |
| Priority 2 service | Tel: | 0686166924 |
| Priority 3 service | Mail: | b.dupont@rd.ft.com |
| Priority 4 service | Web: | www.bertranddupont.fr |

This text is sent at step 414 to the videotex server module (57), which is responsible for downloading at step 415 to the Minitel terminal (5) of the ENUM subscriber.

The videotex page presented to the ENUM subscriber makes it possible, via an adapted interface, to make modifications to the normal ENUM profile: changes to priorities, addition of service, deletion of service, changes to attributes of a service, etc. The request to update the ENUM profile is sent at step 450 to the videotex server (57). The latter at step 451 transmits the request to the ENUM script module (75), which is responsible for formatting the request in accordance with the NAPTR inputs described by the ENUM protocol. The ENUM script (75) then sends an update request at step 452 to the DNS protocol module (62). The latter sends a command DNS UPDATE at step 453 to the DNS protocol module (32) of the DNS server (31) of the ENUM service provider (30). The IP address of the latter is stored in the database (70) and is found from the E.164 number of the ENUM subscriber. The DNS protocol module (32) updates the information in the random access memory of the server (31) and requests the updating of the database (33), which is generally a flat text file. The DNS protocol manages the modification number in this file so that the secondary DNS server or servers can themselves reload this modification at predefined intervals of time. The database (33) confirms the updating at step 455, which results in a response to the update demand request at step 456. The ENUM script (75) at step 457 intercepts the return code of this response and then generates at step 458 the confirmation/invalidation message relating to the taking into account of the modification before sending it to the videotex server (57), which is responsible for formatting the result videotex page before downloading it at step 459 to the Minitel terminal (5).

FIG. 8 illustrates schematically the procedure for consultation and manual modification of an ENUM profile by e-mail of a terminal having an e-mail client (8).

The ENUM subscriber sends a formatted e-mail at step 500 to the e-mail server (61). The ENUM command is for example made in the destination e-mail address:
e164-33296053859-login-dupont-password-1234-request
lire@gestion.enum.francetelecom.com

The ENUM script module (75) has an e-mail client which regularly scrutinises the e-mail server (61). When the ENUM script module (75) at step 501 receives an e-mail as indicated above, it recovers, either in the header or in the body of the e-mail, the arguments supplied and then transmits them at step 502 to the authentication module (73). The authentication module (73) at step 503 interrogates the local or remote database (via an ODBC interface for example), making a search on the E.164 ENUM number. The latter at step 504 supplies the corresponding authentication information to the authentication module (73), which compares it with the pseudonym (login_id) and the password supplied by the ENUM client in the e-mail. In the case of agreement, the authentication module (73) advises the ENUM script module (75) of this at step 505. Consequently the ENUM script (25) sends an interrogation request at step 506 to the DNS protocol management module (62), supplying as an argument the E.164 address of the ENUM subscriber transformed into domain name (transformation of the E.164 telephone number of the type 33296053859 into 9.5.8.3.5.0.6.9.2.3.3.e164.arpa). The DNS protocol management module (62), which fulfils the conventional role of a RESOLVER, interrogates (step 507), if however the information is not already present in its cache following a previous consultation, according to the DNS standard protocol (DNS Query request) successively the level 0 DNS server, the level 1 DNS server and then the level 2 DNS server by the DNS protocol stack (32). Preferably, in order to gain in efficiency, the data of a DNS are loaded into the random access memory of the DNS server (31). If the ENUM subscriber is actually recorded in the DNS (31) of the ENUM service provider (30), then the DNS protocol management module (32) at step 508 returns the corresponding NAPTR records. The DNS protocol management module (62) is responsible for retransmitting them to the ENUM script module (75) at step 509. The latter analyses and interprets the NAPTR records and generates a relatively synthetic text understandable to the ENUM subscriber, of the type:

| | | |
|---|---|---|
| Priority 1 service | Tel: | 0296053859 |
| Priority 2 service | Tel: | 0686166924 |
| Priority 3 service | Mail: | b.dupont@rd.ft.com |
| Priority 4 service | Web: | www.bertranddupont.fr |

This text is despatched (step 510) in e-mail form by the e-mail client software integrated in the ENUM script module to the e-mail server module (61), which is responsible for sending it to the ENUM subscriber.

The ENUM subscriber who wishes to modify his ENUM profile sends an e-mail formatted at step 550 to the e-mail server (61). The ENUM command is for example made in the destination e-mail address, for example:
E164-33296053859-login-dupont-password-1234-request-write-P1-tel-0296053859-P2-tel-0686166924-P3-fax-0296050242@gestion.enum.francetelecom.com.

The e-mail client of the ENUM script module scrutinises the e-mail server (61). When the ENUM script module receives (at 551) an e-mail as indicated above, it recovers, either in the header or in the body of the e-mail, the arguments supplied and then transmits them at step 552 to the authentication module (73). The authentication module (73) at step 553 interrogates the local or remote database (via an ODBC interface for example), making a search on the E.164 ENUM number. This supplies at step 554 the corresponding authentication information and the authentication module (73) compares it with the pseudonym and password supplied in the e-mail. In the event of agreement, the authentication module (73) advises the ENUM script module (75) of this at step 555. The latter formats the request in accordance with the NAPTR inputs described by the ENUM protocol. The ENUM script (75) then transmits an update request at step 556 to the DNS protocol management module (62), which sends a DNS UPDATE command at step 557 to the DNS protocol module (32) of the DNS server (31) of the ENUM service provider (30). The IP address of the latter is stored in the database (70) and is found from the E.164 number of the ENUM subscriber. The DNS protocol module (32) updates the information in the random access memory of the server (31) and requests the updating of the database (33), which is generally a flat text file. The DNS protocol manages the modification number in this file so that the secondary DNS server or servers can themselves reload this modification at predefined intervals of time. The database (33) confirms the updating at step 559, which results in a response to the update demand request at step 560. The ENUM script module (75) at step 561 intercepts the return code of this response and then generates the confirmation/invalidation message relating to the taking into account of the modification. This message is sent (at step 562) in the form of e-mail by the client software integrated in the ENUM script module to the e-mail server (61). The latter at step 563 sends the e-mail in question to the ENUM subscriber, who can consult it on his terminal (8).

FIG. 9 illustrates schematically the procedure for consultation and manual modification of an ENUM profile by UUI (User to User Information) from an ISDN terminal (2).

At step 600 the ENUM subscriber sends from his ISDN terminal (2) a telephone call containing the UUI information element to the ISDN interface (51). It should be recalled that the UUI field is currently limited to a size of 32 characters. The ENUM command which is inserted in the UUI field can therefore act on only one ENUM service at a time. For example: GetP1-33296053859*dupont#123456: this request makes it possible to recover the attributes of the priority 1 ENUM service.

The calling automatic controller (52) at step 601 transmits the message requesting call establishment to the UUI module (53), which will extract the UUI command. The calling automatic controller (52) at step 652 sends the Alert message to the ENUM subscriber so as to allow a minimum amount of time (time delay with the ISDN protocol before sending a disconnection message). The UUI module (53) transmits the ENUM command at step 603 to the ENUM script module (75). The latter recovers the ENUM arguments supplied and then transmits them at step 604 to the authentication module (73). The authentication module (73) at step 605 interrogates the local or remote database (via an ODBC interface for example), making a search on the E.164 ENUM number. This supplies at step 606 the corresponding authentication information to the authentication module (73), which compares it with the pseudonym and password supplied by the ENUM client in the UUI. In the case of agreement, the authentication module (73) advises the ENUM script module (75) of this at step 607. Subsequently the ENUM script module (75) sends an interrogation request at step 608 to the DNS protocol management module (62), supplying as an argument the E.164 address of the ENUM subscriber transformed in the form of a domain (transformation of the E.164 telephone number of the type 33296053859 into 9.5.8.3.5.0.6.9.2.3.3.e164.arpa). The DNS protocol management module (62) which fulfils the conventional role of a RESOLVER can (at step 609) interrogate without having checked whether the information is already in its cache following a previous consultation, using the DNS standard protocol (DNS Query request) the level 0 DNS and then the level 1 DNS, then the level 2 DNS via its DNS protocol module (32). Preferably, in order to gain in efficiency, the data of a DNS server are loaded into the random access memory of the server (31). If the ENUM subscriber is actually recorded in the DNS (31) of the ENUM service provider (30), the DNS protocol stack (32) returns the corresponding NAPTR records at step 610 to the DNS protocol management module (62), which is responsible for retransmitting them to the ENUM script module (75) at step 611. The latter analyses and interprets the NAPTR records and, according to the service requested in the UUI command, generates a relatively synthetic text understandable to the ENUM subscriber, of the type:
Service P1: Tel: 0296053859

This text is sent at step 612 to the UUI module (53), which is responsible for formatting a disconnection message before sending it at step 613 to the calling automatic control module (52). The latter generates the ISDN disconnection message which contains the UUI information and which is therefore transmitted at step 614 via the ISDN network to the terminal (2) of the ENUM subscriber. The latter can display the UUI on the display of his ISDN terminal (2).

The ENUM subscriber who wishes to modify his ENUM profile sends at step 650 from his ISDN terminal (2) a telephone call containing the UUI information element to the ISDN interface (51). For example: DelP3-33296053859*dupont#123456: this request makes it possible to eliminate the priority 3 ENUM service.

The calling automatic controller (52) transmits at step 651 a message requesting the establishment of a call to the UUI module (53), which extracts the UUI command. The calling automatic controller (52) at step 652 sends the alert message to the ENUM subscriber so as to allow itself a minimum amount of time (timing of the ISDN protocol before sending a disconnection message). The UUI module (53) transmits the ENUM command at step 653 to the ENUM script module (75). The latter recovers the arguments supplied and then transmits them at step 654 to the authentication module (73). The authentication module (73) at step 655 interrogates the local or remote database (via an ODBC interface for example), making a search on the E.165 ENUM number. This supplies at step 656 the corresponding authentication information to the authentication module (73), which compares it with the pseudonym and password supplied by the ENUM client in the UUI. In the case of agreement, the authentication module (73) advises the ENUM script module (75) of this at step 657. Given that the modification does not relate to the entire profile, the ENUM script (75) first of all sends an interrogation request (at step 658) to the DNS protocol management module (62), supplying as an argument the E.164 address of the ENUM subscriber transformed in the form of a domain (transformation of the E.164 telephone number of the type 33296053859 into 9.5.8.3.5.0.6.9.2.3.3.e164.arpa). The DNS protocol management module (62), which fulfils the role of RESOLVER, can (at step 659), after having checked whether the information is already in its cache following a previous consultation, by means of the DNS standard protocol (DNS Query request), interrogate the level 0 DNS, the level 1 DNS and the level 2 DNS via its DNS protocol module (32). In order to gain in efficiency, the data of a DNS are loaded into the random access memory of the server (31). If the ENUM subscriber is actually recorded in the DNS (31) of the ENUM service provider (30), the DNS protocol module (32) at step 660 returns the corresponding NAPTR records to the DNS protocol management module (62). The latter is responsible for retransmitting them to the ENUM script module (75) at step 661. The ENUM script (75) then sends an update request taking account of the modification requested in the UUI field at step 662 to the DNS protocol module (62). The latter sends a DNS UPDATE command at step 663 to the DNS protocol module (32) of the DNS server (31) of the ENUM service provider (30). The IP address of the latter is stored in the database (70) and is found from the E.164 number of the ENUM subscriber. The DNS protocol module (32) updates the information in the random access memory of the server (31) and requests the updating of the database (33), which is generally a flat text file. The DNS protocol manages the modification number in this file so that the secondary DNS server or servers can themselves reload this modification at predefined intervals of time. The database (33) confirms the updating at step 665, which results in a response to the update request at step 666. The ENUM script (75) at step 667 intercepts the return code of this response and then at step 668 generates the confirmation/invalidation message relating to the taking into account of the modification. This message is sent at step 668 to the UUI module (53), which is responsible for formatting a disconnection message before sending it at step 669 to the calling automatic controller module (52). The latter at step 670 generates the ISDN disconnection message which contains the UUI information element and which is therefore transmitted via the ISDN network to the terminal (2) of the ENUM subscriber. The latter can display the UUI on the display of his ISDN terminal (2).

FIG. 10 illustrates schematically the procedure for access to the service for consultation and automatic modification of an ENUM profile from a web session. The task consisting of manually modifying an ENUM profile can quickly become tricky and repetitive. An automatic controller (referred to as a configuration automatic controller) is then used to make an automatic modification to the ENUM profile as a function of time and/or other parameters. Amongst these other parameters, the location of the subscriber can be adopted if it is known to the system (50).

At step 700 the ENUM subscriber requests the downloading of the home web page of the management service of the ENUM profile. This is returned at step 701 by the web server (63) of the present invention. This web page displays an authentication form to the ENUM subscriber. The latter enters his E.164 ENUM number and then his login and password. This information is transmitted at step 702 to the web server (63), which itself transmits it (at step 703) to the authentication module (73). The authentication module (73) interrogates (at step 704) the local or remote database (70) (via an ODBC interface for example) making a search on the E.164 ENUM number. This supplies at step 705 the corresponding authentication information to the authentication module (73), which compares it with the pseudonym and password entered by the ENUM client in the web form. In the case of agreement, the authentication module (73) at step 706 notifies the web server module (63) that the authentication has succeeded. The latter sends at step 707 to the ENUM script module (75) a request for reading the automatic configuration for this ENUM profile. The ENUM script module (75) at step 708 interrogates the database (70), supplying as arguments the E.164 number of the ENUM subscriber. The database (70) at step 709 returns the automatic management program for the profile to the ENUM script module (75). The latter formats the information, for example:

Monday to Friday: 0830 to 1900

| | | |
|---|---|---|
| P1 | Tel | 0296053859 |
| P2 | Tel | 0686166924 |
| P3 | e-mail | bertrand.dupont@rd.francetelecom.com |
| P4 | fax | 0296050242 |

Monday to Friday: 1900 to 0830

| | | |
|---|---|---|
| P1 | Tel | 0296916404 |
| P2 | e-mail | bertrand.dupont@rd.francetelecom.com |

Saturday and Sunday: 0000 to 2359

| | | |
|---|---|---|
| P1 | Tel | 0296916404 |
| P2 | Tel | 0686166924 |
| P3 | e-mail | b.dupont@wanadoo.fr |

The ENUM script module (75) transmits the formatted information at step 710 to the web server (63), which is responsible for downloading the web page containing the information in clear from the configuration program of the ENUM profile on the web terminal (8) of the ENUM subscriber.

This web page allows modification of the automatic configuration program of the ENUM profile: changes to timetables, management of public holidays, addition/deletion of services, modifications of service attributes, etc. The ENUM subscriber validates the modification of the program at step 750. The web server (63) transmits this information at step 751 via the ENUM script module (75). The latter extracts the information and formats it in a defined format before writing it in the database (70), at step 752. This takes into account the recording of the program and confirms it at step 753 to the ENUM script module (75). The latter notifies the web server (63) of the taking into account of the modification of the configuration automatic controller of the ENUM profile. The server at step 755 downloads the web page confirming the modification on the web terminal (8) of the ENUM subscriber.

FIG. 11 illustrates the procedure for automatic updating via the configuration automatic controller of the ENUM profiles as well as the optional procedure for notifying change of profile to the ENUM subscriber.

The configuration automatic controller (74) regularly scrutinises the database (70) at step 800 in order to check whether there is a programmed modification to make (according to the current date and time). If a modification is programmed then the configuration parameters are returned at step 801. The configuration automatic controller (74) sends an interrogation request at step 802 to the DNS protocol management module (62), supplying as an argument the E.164 address of the ENUM subscriber whose profile is to be modified, transformed in the form of a domain name (transformation of the E.164 telephone number of the type 33296053859 into 9.5.8.3.5.0.6.9.2.3.3.e164.arpa). The DNS protocol management module (62) which fulfils the role of a RESOLVER can (at step 803), if however the information is not already in its cache following a previous consultation, by means of the DNS standard protocol (DNS Query request), interrogate the level 0 DNS server, the level 1 DNS server and then the level 2 DNS server via his DNS protocol module (32). Preferably, in order to gain in efficiency, the data of a DNS are loaded into the random access memory of the DNS server (31). If the ENUM subscriber is actually recorded in the DNS (31) of the ENUM service provider (30), then the DNS protocol module (32) returns at step 804 the corresponding NAPTR records to the DNS protocol module (62). The latter retransmits them to the configuration automatic controller (74), which then consults (step 806) the database (70) in order to recover the modifications to be made on the ENUM profile. The database returns (step 807) the profile to be applied to the configuration automatic controller module (74). If a modification is actually necessary (the profile has been able to be modified manually in the meantime), the configuration automatic controller determines the modifications to be made to the NAPTR records and sends an update request at step 808 to the DNS protocol management module (62). The latter sends a DNS UPDATE command at step 809 to the DNS protocol module (32) of the DNS server (31) of the ENUM service provider (30). The IP address of the latter is stored in the database (70) and is found from the E.164 number of the ENUM subscriber. The DNS protocol module (32) updates the information in the random access memory of the server (31) and requests the updating of the database (33), which is generally a flat text file. The DNS protocol manages the modification number in this file so that the secondary DNS server or servers can themselves reload this modification at predefined intervals of time. The database (33) confirms the updating at step 811, which results in a response to the update demand request at step 812. The configuration automatic controller (74) at step 813 intercepts the return code of this response and then at step 814 generates a request to write in the database (70) in order to supply the journal of modifications. The database (70) confirms the writing of the profile automatic modification event at step 815.

If the automatic update service has been configured in order to notify the automatic modifications to the ENUM profile, the configuration automatic controller notifies the updating according to one or more of the following modes:
in the case where the notification is in voice mode, the configuration automatic controller (74) notifies the calling automatic controller (52) at step 820, which results in a telephone call to an STN (4) or ISDN (2) or IP (7) fixed telephone, or to a mobile telephone (6). The notification information and addresses are stored in the database (70). The ENUM subscriber responds to this telephone call at step 822 or the call is switched to its voice messaging. The voice synthesis module (55) or the voice file broadcast module (56) at step 823 broadcast the notification of the ENUM profile modification, for example: “hello, your ENUM profile 33296053859 was updated today at 1900 as follows: telephone service to 0296053859 and then telephone service to 0686166924 and then e-mail service to bertrand.dupont@wanadoo.fr”;
in the case where the notification is in SMS mode, the configuration automatic controller (74) advises the SMS module (58) at step 830 by supplying the text of the SMS, for example of the type: “Modification of your ENUM profile 33296053859 on Mar. 21, 2002 at 0900: Tel: 0296053859, Tel: 0686166924, Fax: 0296050242”. The SMS module (58) at step 840 transmits this SMS message to the mobile or fixed telephone terminal, as configured in the database (70);
in the case where the notification is in e-mail mode, the configuration automatic controller (74) notifies the updating to the e-mail server (61) (step 850) by means of an e-mail containing a text of the type: “Modification of your ENUM profile 33296053859 on Mar. 21, 2002 at 0900: Tel: 0296053859, Tel: 0686166924, Fax: 0296050242”. To this end, the configuration automatic controller has an e-mail client. The e-mail server (61) then at step 860 transmits the e-mail in question to the e-mail address stored in the database (70);
in the case where the notification is in fax mode, the configuration automatic controller (74) notifies the fax module (59) at step 870, supplying the text of the fax, which could be of the type: “Modification of your ENUM profile 33296053859 on Mar. 21, 2002 at 0900: Tel: 0296053859, Tel: 0686166924, Fax: 0296050242”. The fax module (59) at step 880 transmits this fax to the fax terminal (9) configured in the database (70).

FIG. 12 illustrates an example of a procedure for consulting the ENUM profile when the latter is stored in an LDAP directory. The example given in FIG. 12 illustrates a consultation via an individual computer but it is clear that the consultation can be carried out by means of other types of terminals previously envisaged. This type of service could in particular be offered by companies which wish to offer access to an ENUM service to all or some of their employees.

The ENUM subscriber at step 900 requests the downloading of the home web page of the ENUM profile management service. This is returned at step 901 by the web server (63) of the system (50). This web page displays an authentication form for the ENUM subscriber. The latter enters his E.164 ENUM number and then his pseudonym and password. This information is transmitted at step 902 to the web server (63), which itself transmits it (step 903) to the authentication module (73). The authentication module (73) interrogates (step 904) the local or remote database (via an ODBC interface for example), making a search on the E.164 ENUM number. This supplies at step 905 the corresponding authentication information to the authentication module (73), which is responsible for comparing it with the pseudonym and password entered by the ENUM client. In the event of agreement, the authentication module (73) at step 906 notifies the web server module (63) that the authentication has succeeded. The latter at step 907 sends to the ENUM script module (75) an ENUM profile read request. The ENUM script (75) sends an interrogation request at step 908 to the DNS protocol management module (62), supplying as an argument the E.164 address of the ENUM subscriber transformed in the form of a domain (transformation of the E.164 telephone number of the type 33296053859 into 9.5.8.3.5.0.6.9.2.3.3.e164.arpa). The DNS protocol management module (62) which fulfils the role of a RESOLVER interrogates (step 909), if the information is not already in its cache following a previous consultation, by means of the DNS standard protocol (DNS Query request), the level 0 DNS server, the level 1 DNS server and then the level 2 DNS server via its DNS protocol module (32). Preferably, in order to gain in efficiency, the data of a DNS are loaded into the random access memory of the server (31). If the ENUM subscriber is actually recorded in the DNS server (31) of the ENUM service provider (30), the DNS protocol management module (32) at step 910 returns the corresponding NAPTR record or records. The DNS protocol management module (62) is responsible for retransmitting them to the ENUM script module (75) at step 911. The latter analyses and interprets the NAPTR record or records, for example:

$ORIGIN 9.5.8.3.5.0.6.9.2.3.3.e164.arpa.

```
IN NAPTR 100 10 “u”
      “ldap+E2U””!\hat{ }.+33296053859$!ldap://ldap.providerA.fr/cn=
      33296053859!”
```

The ENUM script detects that it is a case of an LDAP service. Consequently the ENUM script module (75) at step 912 sends to the LDAP protocol management module (64) a request LDAP demanding connection to the LDAP server referenced by the URI “ldap://ldap.providerA.fr”. At step 913 the latter sends a request “Bind” to the LDAP protocol module (35) of the LDAP directory server (34) of the ENUM A supplier (30). The LDAP protocol module (35) accepts the connection at step 914. The LDAP protocol management module (64) then sends at step 915 to the LDAP protocol module (35) the LDAP request “Search” supplying the E.164 number of the ENUM subscriber as an argument. The LDAP protocol module (35) interrogates the LDAP database (36) at step 916 and then returns (at step 917) all the information concerning the ENUM subscriber to the LDAP protocol module (35), which itself returns it (step 918) to the LDAP protocol management module (64). The latter returns the information at step 919 to the ENUM script (75), which is responsible for putting it in a form understandable to the ENUM subscriber before transmitting it (at step 922) to the web server (63). The server then downloads the web page generated dynamically at step 923 on the web terminal (8) of the ENUM subscriber. In parallel, the LDAP protocol management module (64) at step 920 sends a disconnection request to the LDAP server (34) via a request “Unbind”. The LDAP protocol module (35) confirms the disconnection at step 921.

FIG. 13 describes the procedure for the manual modification of an ENUM profile when the latter is stored in an LDAP directory. There too, a modification of an ENUM profile by a terminal other than a PC can of course be envisaged.

An ENUM subscriber who has previously consulted the content of his ENUM profile by means of the procedure described above may decide to modify it. To do this, he modifies locally in the web page displayed on the web terminal (8) the attributes of his ENUM services and the priorities and adds services or deletes some of them. He validates his profile modifications at step 1000 and the information supplied to the web server (63). The latter transmits all this information at step 1001 to the ENUM script module (75). The latter sends an interrogation request at step 1002 to the DNS protocol module (62), supplying as an argument the E.164 address of the ENUM subscriber transformed in the form of a domain (transformation of the E.164 telephone number of the type 33296053859 into 9.5.8.3.5.0.6.9.2.3.3.e164.arpa). The DNS protocol management module (62), which fulfils the role of a RESOLVER, can, if the information is not already in its cache following a previous consultation (at step 1003), with the DNS standard protocol (DNS Query request), interrogate the level 0 DNS, then the level 1 DNS, before interrogating the level 2 DNS via its DNS protocol module (32). To gain in efficiency, the data of a DNS are loaded in the random access memory of the DNS server (31). If the ENUM subscriber is actually recorded in the DNS (31) of the ENUM service provider (30) the DNS protocol module (32) at step 1004 returns the corresponding NAPTR record or records. The DNS protocol management module (62) then retransmits them to the ENUM script module (75) at step 1005. The latter analyses and interprets the NAPTR record or records, for example:

$ORIGIN 9.5.8.3.5.0.6.9.2.3.3.e164.arpa.

```
IN NAPTR 100 10 “u”
      “ldap+E2U””!\hat{ }.+33296053859$!ldap://ldap.providerA.fr/cn=
      33296053859!”
```

The ENUM script module (75) detects whether it is a case of an LDAP service. The ENUM script module (75) then sends (step 1006) to the LDAP protocol module (64) an LDAP request demanding connection to the LDAP server referenced by the URI “ldap://ldap.providerA.fr”. The latter at step 1007 sends a request “Bind” to the LDAP protocol module (35) of the LDAP directory server (34) of the ENUM A supplier (30). The LDAP protocol module (35) accepts the connection at step 1008. The LDAP protocol module (64) then at step 1009 sends to the LDAP protocol module (35) an LDAP request “Search”, supplying the E.164 number of the ENUM subscriber as an argument. The LDAP protocol module (35) interrogates the LDAP database (36) at step 1010 and then at step 1011 returns all the information concerning the ENUM subscriber to the LDAP protocol management module (35). The latter returns it at step 1012 to the LDAP protocol management module (64), which itself returns it (step 1013) to the ENUM script module (75). The latter compares it with the information supplied via the web by the ENUM subscriber and determines the operation to be performed to the LDAP format and transmits a modification request at step 1014 to the LDAP protocol management module (64). The latter sends an LDAP request “Modify” at step 1015 to the LDAP protocol module (35), which itself at step 1016 sends a request to write in the database (36). The latter accepts the updating and confirms it (step 1017) to the LDAP protocol module (35). The latter transmits (step 1018) the confirmation/invalidation concerning updating to the LDAP protocol management module (54), which returns it (step 1019) to the ENUM script module (75). The latter then generates the modification confirmation web page before transmitting it to the web server (63). The server downloads this page (step 1023) to the web terminal (8) of the ENUM subscriber. In parallel, the LDAP protocol module (64) sends (step 1020) a disconnection request to the LDAP server (34) via a request “Unbind”. The LDAP protocol module (35) confirms the disconnection at step 1021.

Although the procedure for updating the LDAP directory or has been illustrated for a “manual” procedure, it goes without saying that an automatic updating of the LDAP directory by means of the configuration automatic controller (74) can also be envisaged.

Although the invention has essentially been described in the context of the “ENUM” application and the updating of the ENUM profile, it is clear to a person skilled in the art that it can be extended to the updating of one or more resource records (RR) in a DNS (or LDAP) server, as defined in paragraph 3.2.2 of the aforementioned document RFC 1035 and set out in the table below:

| Type of RR | Value | Meaning |
|---|---|---|
| A | 1 | IP address of a machine |
| NS | 2 | Name of server managed by |
| | | an administrative authority |
| MD | 3 | Destination mail server |
| MF | 4 | Rerouting mail server |
| CNAME | 5 | Canonical name for an alias |
| SOA | 6 | Marks start of an area of authority |
| MB | 7 | Domain name of an e-mail box |
| MG | 8 | Member of mail group |
| MR | 9 | Domain name renaming a mail |
| NULL | 10 | Resource record NULL |
| WKS | 11 | Well-known service description |
| PTR | 12 | Pointer to a domain name |
| HINFO | 13 | Information on a computer machine |
| MINFO | 14 | Information on a mail box |
| MX | 15 | Mail exchange |
| TXT | 16 | Character strings |

For a given resource record, the updating can relate to one or more fields of this record, as defined in the aforementioned document RFC 1035.

It should be noted that, if the updating of a resource record or records other than NAPTR is envisaged, new modules similar to the module “ENUM Script” (75) and “ENUM configuration automatic controller” (74) must be added to process each of these records.

1-32. (canceled)

33. System for consulting and/or updating a record stored in a first database, the record including one or a plurality of resource records, the first database being stored by a domain name server, referred to as a DNS server, or a directory server, referred to as an LDAP server, able to be accessed indirectly from a DNS server, the system comprising:
a communication arrangement enabling the said system to receive from a telecommunication terminal a request for consultation and/or modification of the record or a programming of such a request;
a controller for determining, from said consultation and/or modification request transmitted to the said system or previously programmed in the said system, a domain name and an operation to be performed on the record;
a protocol manager for seeking, from the domain name, the IP address of the server storing the said first database and, according to the operation, for transmitting to the server a request to read or update the record.

34. System according to claim 33, further comprising an authenticator for authenticating, at the application level, the sender of the request from authentication information stored in a second local or remote database.

35. System according to claim 34, wherein the protocol manager is arranged to respond to an indication of the sender of the request having been authenticated by (a) transmitting a consultation request according to the DNS protocol to the DNS server, the request having as its argument the domain name, and (b) receiving a first response from the server.

36. System according to claim 35, wherein the controller is arranged to store the first database by the DNS server by (a) extracting from the first response information included in the record and (b) formatting the information in order to transmit the information to said terminal via the communication arrangement.

37. System according to claim 35, wherein the LDAP server is arranged to store the first database, the controller being arranged to extract the address of the LDAP server from the first response.

38. System according to claim 37, wherein the protocol manager is arranged to transmit a consultation request according to the LDAP protocol to the LDAP server and to receive a second response from the LDAP server.

39. System according to claim 38, wherein the controller is arranged to extract from the second response information included in the record and to format it for transmission to the terminal via the communication arrangement.

40. System according to claim 36, wherein the controller is arranged to respond to an updating operation determined by the controller to instruct the protocol manager to transmit an update request according to the DNS protocol.

41. System according to claim 40, wherein the protocol manager is arranged to receive an updating confirmation/invalidation response from the DNS server and the controller is arranged to format the updating confirmation/invalidation response before ordering transmission of the updating confirmation invalidation response to the terminal via the communication arrangement.

42. System according to claim 39, wherein the controller is arranged to respond to an updating operation determined by the controller to instruct the protocol manager to transmit an update request according to the LDAP protocol.

43. System according to claim 40, wherein the protocol manager is arranged to receive an updating confirmation/invalidation response from the LDAP server and the controller is arranged to format the updating confirmation/invalidation response before ordering transmission of the updating confirmation invalidation response to the terminal via the communication arrangement.

44. System according to claim 34, wherein the controller is arranged to store in the second database a configuration profile transmitted via the communication arrangement, the profile including one or more programmed modification requests, each programmed modification request being associated with at least one time range and/or one geographical area.

45. System according to claim 44, wherein the controller comprises a configuration automatic controller for (a) scrutinizing the second database and testing whether a measurement of time belongs to the range and/or a location of the terminal belongs to the area, and, in response to a positive result, (b) extracting the associated programmed modification request and transmitting to the protocol manager a request to consult the first database.

46. System according to claim 45, wherein the protocol manager is arranged to formulate the consultation request according to the DNS protocol or LDAP protocol (LDAP Search) and to receive, from the server storing the database, the content of the record.

47. System according to claim 46, wherein the controller is arranged to respond to the content of the record not being in accordance with the programmed modification request by (a) determining an operation to be performed on the record to make the record conform to the programmed modification request and (b) cause the protocol manager to formulate, according to the operation, a request for (i) updating the first database according to the DNS or LDAP protocol and (ii) routing to the server storing the first database.

48. System according to claim 47, wherein the protocol manager is arranged to receive an updating confirmation/invalidation response from the server storing the first database, and the controller is arranged to detect the confirmation/invalidation response and to store it in history form in the second database.

49. System according to claim 48, wherein the said controller is arranged to receive a request to read the history, and, in response to authentication of the sender of the request via the authentication arrangement, to transmit to him the content of the history via the communication arrangement.

50. System according to claim 49, wherein the protocol manager is arranged to receive an updating confirmation/invalidation response from the server storing the first database, and the controller is arranged to detect the confirmation/invalidation response and to transmit a report on the operation to a notification terminal.

51. System according to claim 33, wherein the protocol manager is arranged to use a DNS protocol of the secure type.

52. System according claim 33, wherein the system comprises an STN and/or ISDN interface for connecting the said communication arrangement to the STN/ISDN network.

53. System according to claim 52, wherein the communication arrangement comprises a voice synthesis module or a voice file reproduction module for generating a voice menu and reproducing one or more items of information on the recorded voice form, and a recognition module for DTMF signals and/or a voice recognition module for recognising a choice in the voice menu.

54. System according to claim 52, wherein the communication arrangement comprises a videotex server for managing a menu, to enter a request for consultation or modification of the record and to reproduce one or more items of information about the record or an update confirmation/invalidation response in the form of videotex sequences.

55. System according to claim 52, wherein the communication arrangement comprises an SMS message sending/receiving module for receiving in the form of a message a request for consultation or modification of the record and transmitting in the form of a message one or more items of information about the record or an updating confirmation/invalidation response.

56. System according to claim 52, further comprising an ISDN interface, wherein the communication arrangement comprises a UUI user to user information sending/receiving module, for receiving, in the form of an item of UUI information, a request for consultation or modification of the record and to transmit in the form of an item of UUI information, one or more items of information about the record or an updating confirmation/invalidation response.

57. System according to claim 52, further comprising a fax module for transmitting one or more items of information about the record or an updating confirmation/invalidation response.

58. System according to claim 33, wherein the system comprises an IP interface.

59. System according to claim 58, wherein the communication arrangement comprises a web server for transmitting (a) an authentication form, and (b) a form for entering a request for consultation or modification of said record, representing one or more items of information about the record or an updating confirmation/invalidation response in the form of web pages.

60. System according to claim 58, wherein the communication arrangement comprises an SMTP server for receiving, in the form of e-mails, a request for consultation or modification of the record and for transmitting in the form of e-mails one or more items of information about the record and/or an updating confirmation/invalidation response.

61. System according to claim 33, wherein the controller is arranged to determine a domain name from a subscriber identifier.

62. System according to claim 61, wherein the subscriber identifier is the E.164 telephone number of the subscriber.

63. System according to claim 61 wherein the controller is arranged to extract information and to determine according to the request an operation to be performed on a resource record of the Naming Authority PoinTeR.

64. System according to claim 33 wherein the controller is arranged to extract information and to determine, according to the request, an operation to be performed on one or more resource records of the A, NS, MD, MF, CNAME, SOA, MB, MG, MR, NULL, WKS, PTR, HINFO, MINFO, MX or TXT type.
